(19) United States
(12) Patent Application Publication
(10) Pub. No.: US 2025/0123803 A1
(43) Pub. Date: Apr. 17, 2025

(54) POLYNOMIAL RING VECTOR INNER PRODUCT COMPUTATION CIRCUIT, COMPUTATION PROCESSING CIRCUIT, AND CONTROL METHOD

(71) Applicant: Kioxia Corporation, Tokyo (JP)

(72) Inventor: Yoshihiro OHBA, Kawasaki Kanagawa (JP)

(73) Assignee: Kioxia Corporation, Tokyo (JP)

(21) Appl. No.: 18/823,942

(22) Filed: Sep. 4, 2024

(30) Foreign Application Priority Data
Oct. 13, 2023 (JP) 2023-177596

(51) Int. Cl. G06F 7/523

(52) U.S. Cl. CPC G06F 7/523

(57) ABSTRACT

According to one embodiment, the polynomial ring vector inner product computation circuit computes an inner product between a first frequency domain polynomial ring vector and a second frequency domain polynomial ring vector, based on the first frequency domain polynomial ring vector obtained by preliminarily executing a process of multiplying each of one or more constant polynomials by 1/N and a process of applying the number theoretic transform to each of the one or more constant polynomials, and outputs a time domain polynomial obtained by applying inverse number theoretic transform to the computed inner product as an inner product between a first polynomial ring vector and a second polynomial ring vector.

### CROSS-REFERENCE TO RELATED APPLICATIONS

This application is based upon and claims the benefit of priority from Japanese Patent Application No. 2023-177596, filed Oct. 13, 2023, the entire contents of which are incorporated herein by reference.

### FIELD

Embodiments described herein relate generally to a polynomial ring vector inner product computation circuit, a computation processing circuit, and a control method, for controlling computation of polynomial ring vectors.

### BACKGROUND

In recent years, data encrypted based on the homomorphic encryption, among data encrypted for data protection, can be computed in its encrypted state. In other words, the data encrypted using the homomorphic encryption is the data that can be computed without decryption (secure computation).

Furthermore, data encrypted using fully homomorphic encryption, among the homomorphic encryption, is the data that can be subjected to any secure computation. The data and the encryption key, encrypted using the fully homomorphic encryption, can be represented by polynomial ring vectors. For this reason, computations between polynomial ring vectors are executed in the secure computation of the data encrypted using the fully homomorphic encryption, and the like.

In the computations between the polynomial ring vectors, the amount of computation increases and the time required for the computation increases, according to the size of these polynomial ring vectors.

For this reason, a technique to efficiently execute the computation of the encrypted data by efficiently executing the computation between the polynomial ring vectors is required.

### BRIEF DESCRIPTION OF THE DRAWINGS

FIG. 1 illustrates a processing flow of Cooley-Tukey (CT) butterfly operation.

FIG. 2 illustrates a processing flow of Gentleman-Sande (GS) butterfly operation.

FIG. 3 illustrates a first example of a processing flow of fast Fourier transform using the CT butterfly operation.

FIG. 4 illustrates a second example of the processing flow of fast Fourier transform using the CT butterfly operation.

FIG. 5 illustrates a first example of a processing flow of fast Fourier transform using the GS butterfly operation.

FIG. 6 illustrates a second example of the processing flow of fast Fourier transform using the GS butterfly operation.

FIG. 7 illustrates a processing flow of Number Theoretic Transform (NTT).

FIG. 8 illustrates a processing flow of Inverse NTT.

FIG. 9 is a flowchart illustrating a procedure of a bootstrapping key setting process executed in the embodiment.

FIG. 10 is a flowchart illustrating a procedure of a private functional key switching key setting process executed in the embodiment.

FIG. 11 is a flowchart illustrating a procedure of a private functional key switching process for the private functional key switching key executed in the embodiment.

FIG. 12 is a flowchart illustrating procedure of CMux function executed in the embodiment.

FIG. 13 is a block diagram illustrating a configuration of a CMux operation circuit according to the embodiment.

FIG. 14 is a block diagram illustrating an example of a configuration of a computing storage device including an accelerator according to the embodiment.

FIG. 15 illustrates an example of a secure computation instruction set used by the accelerator according to the embodiment.

FIG. 16 illustrates an example of a method of computing virtual register numbers according to the embodiment.

FIG. 17 illustrates an example of a procedure of a key setting process and CMux function process executed in the embodiment.

FIG. 18 illustrates the configuration of the computing storage device configured to execute communication with a host based on the NVMe standard in the embodiment.

FIG. 19 illustrates a configuration in which an accelerator according to the embodiment is arranged inside an SSD controller.

FIG. 20 illustrates a configuration in which the accelerator according to the embodiment is arranged inside an NVMe-oF target module.

### DETAILED DESCRIPTION

In general, according to one embodiment, a polynomial ring vector inner product computation circuit is configured to compute an inner product between a first polynomial ring vector and a second polynomial ring vector, where each component of at least the first polynomial ring vector, of the first polynomial ring vector and the second polynomial ring vector over an integer coefficient polynomial ring using the polynomial x^{N}+1 as ideal, is a linear sum of one or more constant polynomials. The N is a power of 2. The polynomial ring vector inner product computation circuit comprises a number theoretic transform processing circuit, an Hadamard inner product computation circuit, an inverse number theoretic transform processing circuit, and an inner product output circuit. The number theoretic transform processing circuit computes a frequency domain polynomial ring vector that is obtained by applying number theoretic transform to each component of the polynomial ring vector. The Hadamard inner product computation circuit computes an Hadamard product between a first frequency domain polynomial ring vector and a second frequency domain polynomial ring vector that is obtained by applying number theoretic transform to each component of the second polynomial ring vector by the number theoretic transform processing circuit, based on the first frequency domain polynomial ring vector having as each component a linear sum of one or more frequency domain constant polynomials obtained by preliminarily executing a process of multiplying each of the one or more constant polynomials by 1/N and a process of applying number theoretic transform to each of the one or more constant polynomials. The Hadamard inner product computation circuit computes a first inner product, which is a frequency domain polynomial, by computing a sum of components of the computed Hadamard product. The inverse number theoretic transform processing circuit computes a time domain polynomial that is obtained by applying inverse number theoretic transform to the first inner product. The inner product output circuit outputs the computed time domain polynomial.

The embodiments are described below with reference to the accompanying drawings.

First, polynomial multiplication used in the secure computation executed in the embodiment will be described.

In Fully Homomorphic Encryption (FHE), when [symbol] ₚ [symbol] [symbol] /p [symbol] and p is a prime number satisfying p=1 (mod 2N), number-theoretic-transform (NTT) is used as a method of executing fast multiplication of two polymers over integer coefficient polynomial ring R [symbol] [symbol] ₚ[X]/(x^{N}+1). The integer coefficient polynomial ring R [symbol] [symbol] ₚ[X]/(x+1) is an integer coefficient polynomial ring using x^{N}+1 as an ideal.

[symbol] denotes a set of integers, [symbol] denotes a set of real numbers, and [symbol] denotes a set of toruses defined by [symbol] = [symbol] /Z. In addition, [symbol] ₚ [symbol] [symbol] /p [symbol] denotes a quotient set of [symbol] in a case where [symbol] ₚ uses p as modulus. p=1 (mod 2N) denotes that the remainder of p divided by 2N is equal to the remainder of 1 divided by 2N. N is a power number of 2.

The multiplication of two polynomials over an integer coefficient polynomial ring is hereafter referred to as polynomial ring multiplication. In the polynomial ring multiplication using number theoretic transform, Discrete Fourier Transform (DFT) is used for polynomial ring multiplication, and NTT twiddle factors are used for modulo computation using ideals (x^{N}+1).

A coefficient vector c of c (x)=a(x)b(x) mod (x^{N}+1), which is a product between two polynomials a(x) and b(x) over R computed using NTT, can be computed using DFT and Inverse DFT (IDFT) in Equation (1).

$$c = \frac{1}{N} {IDFT}^{( N )} ( {DFT}^{( N )} ( a ⊙ {Ψ}_{N} ) ⊙ {DFT}^{( N )} ( b ⊙ {Ψ}_{N} ) ) ⊙ {Ψ}_{N}^{- 1} \qquad ( 1 )$$

⊙ is the operator representing the product between components of two vectors (Hadamard product). a is a coefficient vector of polynomial a(x) and b is a coefficient vector of polynomial b(x).

Also, DET^{(N)}(f)=(DFTᵢ^{(N)}(f)) 0≤i≤N−1, DETᵢ^{(N)}(f)=Σⱼ₌₀^{N-1}fⱼω_{N}^{ij}, IDET^{(N)}(F)=(IDFTᵢ^{(N)}(F)) 0≤i≤N−1, IDFTᵢ^{(N)}(F)=Σⱼ₌₀^{N-1}Fⱼω_{N}^{-ij}, Ψ_{N}=(1, Ψ_{N}, Ψ_{N}² . . . , Ψ_{N}^{N-1}), and Ψ_{N}⁻¹=(1, Ψ_{N}⁻¹, Ψ_{N}⁻² . . . Ψ_{N}^{-(N-1)}) is satisfied. Ψ_{N} and Ψ_{N}⁻¹ are referred to as an NTT twiddle factor vector and an INTT twiddle factor vector, respectively. For the DFT twiddle factor and the NTT twiddle factor, the relational expression ω_{N}^{N}=1, ω_{N}^{N}/2=−1, ω_{N}^{2j}=ω_{N/2}^{j}, ψ_{N}^{2N}=1, ψ_{N}^{N}=−1, and ψ_{N}^{2j}=ψ_{N/2}^{j} is established.

If NTT^{(N)} (f)≙DET^{(N)} (f⊙ΨN), INTT^{(N)} (F)≙IDET^{(N)} (F)⊙Ψ_{N}⁻¹ are put, the formula for polynomial multiplication by NTT is given by Equation (2).

$$c = \frac{1}{N} {INTT}^{( N )} ( {NTT}^{( N )} ( a ) ⊙ {NTT}^{( N )} ( b ) ) \qquad ( 2 )$$

In other words, the polynomial ring multiplication using the number theoretic transform is realized by the following processes 1 through 4.

Process 1: For each of two polynomials that are inputs of the polynomial ring multiplication using the number theoretic transform, the process (a⊙Ψ_{N}, b⊙Ψ_{N}) (process 1a) of computing the Hadamard product between the coefficient vector (a or b), which is the input of DFT, and the NTT twiddle factor vector (Ψ_{N}), and the process of applying DFT to each of the outputs of process 1a (DFT^{(N)} (a⊙Ψ_{N}), DFT^{(N)} (b⊙Ψ)) (process 1b) are executed.

Process 2: The process (DFT^{(N)} (a⊙Ψ_{N})⊙DFT^{(N)} (b⊙Ψ)) of computing the Hadamard product between the two outputs of process 1b corresponding to two polynomials that are the inputs respectively is executed.

Process 3: The process of applying IDFT to the output of process 2 (IDFT^{(N)} (DFT^{(N)} (a⊙Ψ_{N})⊙DFT^{(N)} (b⊙Ψ))) is executed.

Process 4: The process of computing the Hadamard product between the output of process 3 and the INTT twiddle factor vector and multiplying the computed Hadamard product by 1/N

$$( \frac{1}{N} {IDFT}^{( N )} ( {DFT}^{( N )} ( a ⊙ {Ψ}_{N} ) ⊙ {DFT}^{( N )} ( b ⊙ {Ψ}_{N} ) ) ⊙ {Ψ}_{N}^{- 1} )$$

is executed.

Among these processes, the process 1a is referred to as NTT pre-processing and the process 4 is referred to as INTT post-processing.

DFT and IDFT are realized by an algorithm that is obtained by combining basic operations referred to as butterfly operations in multiple stages. The computational complexity of the algorithm is O(N log N). Such an algorithm is referred to as Fast Fourier Transform (FFT). In addition, the inverse transform of the FFT is referred to as Inverse FFT (IFFT). O(N log N) represents the order of time relating to the computation and indicates that the amount of computation increases as the amount of data N increases.

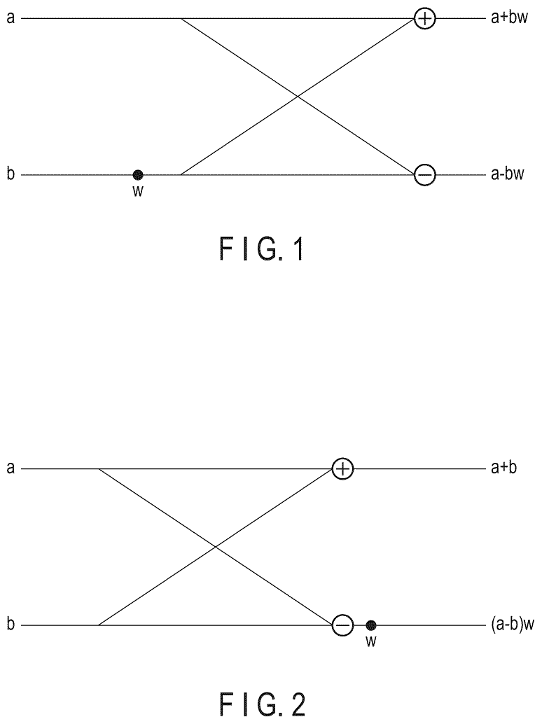

There are two types of butterfly operations, i.e., Cooley-Tukey (CT) butterfly operation and Gentleman-Sande (GS) butterfly operation. FIG. 1 illustrates a processing flow of the CT butterfly operation. FIG. 2 illustrates a processing flow of the GS butterfly operation. FIG. 1 and FIG. 2 show the CT and GS butterfly operations in a case where the radix is 2 (2 inputs and 2 outputs), respectively. When the inputs are a and b and the weight is w, a+wb and a−wb are output by the CT butterfly operation, while a+b and (a−b)w are output by the GS butterfly operation.

First, the FFT using the CT butterfly operation will be described. The FFT using the CT butterfly operation is represented in the following manner by classifying the inputs into even terms and odd terms. When the number of components of f is N, fₑᵥₑₙ represents even component of f and is a vector in which the number of components is N/2, and f_{odd} represents odd component of f and is a vector in which the number of components is N/2.

(1) When 0≤i<N/2,

$$\begin{matrix}{DFT}_{i}^{( N )} ( f ) = {\sum }_{j = 0}^{N - 1} {f}_{j} {ω}_{N}^{ij} \\ = {\sum }_{j = 0}^{N / 2 - 1} {f}_{2 j} {ω}_{N}^{i ( 2 j )} + {\sum }_{j = 0}^{N / 2 - 1} {f}_{2 j + 1} {ω}_{N}^{i ( 2 j + 1 )} \\ = {\sum }_{j = 0}^{N / 2 - 1} {f}_{2 j} {ω}_{N / 2}^{ij} + {ω}_{N}^{i} {\sum }_{j = 0}^{N / 2 - 1} {f}_{2 j + 1} {ω}_{N / 2}^{ij} \\ = {DFT}_{i}^{( N / 2 )} ( {f}_{even} ) + {ω}_{N}^{i} {DFT}_{i}^{( N / 2 )} ( {f}_{odd} )\end{matrix} \qquad ( 3 )$$

(2) When N/2≤i<N,

$$\begin{matrix}{DFT}_{i}^{( N )} ( f ) = {\sum }_{j = 0}^{N / 2 - 1} {f}_{2 j} {ω}_{N}^{( i - N / 2 ) ( 2 j )} + {\sum }_{j = 0}^{N / 2 - 1} {f}_{2 j + 1} {ω}_{N}^{( i - N / 2 ) ( 2 j + 1 )} \\ = {\sum }_{j = 0}^{N / 2 - 1} {f}_{2 j} {ω}_{N / 2}^{ij} - {ω}_{N}^{i} {\sum }_{j = 0}^{N / 2 - 1} {f}_{2 j + 1} {ω}_{N / 2}^{ij} \\ = {DFT}_{i}^{( N / 2 )} ( {f}_{even} ) - {ω}_{N}^{i} {DFT}_{i}^{( N / 2 )} ( {f}_{odd} )\end{matrix} \qquad ( 4 )$$

where, for a vector f=(fo) with component number 1, DFT₀⁽¹⁾ (f)=f₀ is represented.

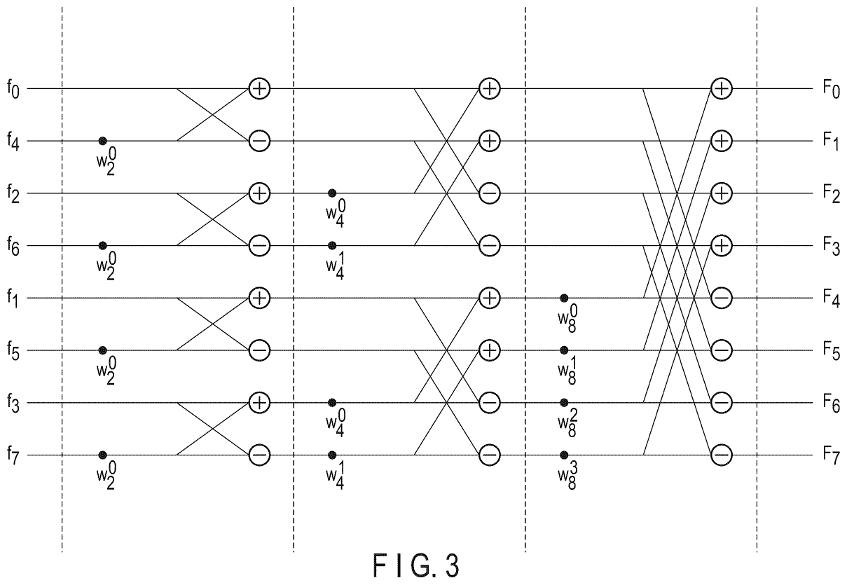

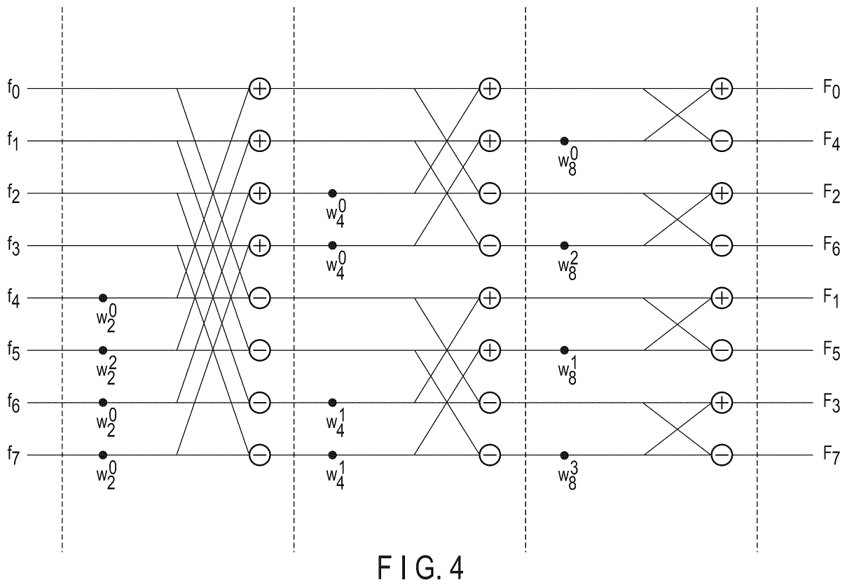

Two types of configurations of the FFT using the CT butterfly operation are shown in FIG. 3 and FIG. 4. FIG. 3 illustrates a first example of the processing flow of the FFT using the CT butterfly operation. FIG. 4 illustrates a second example of the processing flow of the FFT using the CT butterfly operation. In the FFT of FIG. 3, the input indices are arranged in bit-reversed order and the output indices are arranged in natural order. In contrast, in the FFT of FIG. 4, the input indices are arranged in natural order and the output indices are arranged in bit-reversed order.

Next, the FFT using the GS butterfly operation will be described.

In the FFT using GS butterfly operation, the output of DFTᵢ^{(N)} (f) is divided into two upper and lower parts as described in the FFT using the GS butterfly operation, then DFTᵢ^{(N)} (f) is transformed as indicated by Equation (5).

$${DFT}_{i}^{( N )} ( f ) = {\sum }_{j = 0}^{N - 1} {f}_{j} {ω}_{N}^{ij} = {\sum }_{j = 0}^{N / 2 - 1} {f}_{j} {ω}_{N}^{ij} + {\sum }_{j = 0}^{N / 2 - 1} {f}_{j + N / 2} {ω}_{N}^{i ( j + N / 2 )} \qquad ( 5 )$$

Then, FFT using the GS butterfly operation is represented by classifying the output of DFTᵢ^{(N)} (f) into even and odd terms as described below.

(1) When i=2r (0≤r<N/2), with

$${g}_{FFT} {=}^{Δ} {( {f}_{j} + {f}_{j + N / 2} )}_{0 \leq j < 2 / N} , \qquad ( 6 )$$

$$\begin{matrix}{DFT}_{2 r}^{( N )} ( f ) = {\sum }_{j = 0}^{N / 2 - 1} {f}_{j} {ω}_{N}^{2 rj} + {\sum }_{j = 0}^{N / 2 - 1} {f}_{j + N / 2} {ω}_{N}^{2 r ( j + N / 2 )} \\ = {\sum }_{j = 0}^{N / 2 - 1} {f}_{j} {ω}_{N / 2}^{rj} + {\sum }_{j = 0}^{N / 2 - 1} {f}_{j + N / 2} {ω}_{N / 2}^{rj} \\ = {\sum }_{j = 0}^{N / 2 - 1} ( {f}_{j} + {f}_{j + N / 2} ) {ω}_{N / 2}^{rj} \\ = {DFT}_{r}^{( N / 2 )} ( g )\end{matrix}$$

(2) When i=2r+1 (0≤r<N/2), with

$${h}_{FFT} {=}^{Δ} {( {f}_{j} - {ω}_{N}^{j} {f}_{j + N / 2} )}_{0 \leq j < 2 / N} , \qquad ( 7 )$$

$$\begin{matrix}{DFT}_{2 r + 1}^{( N )} ( f ) = {\sum }_{j = 0}^{N / 2 - 1} {f}_{j} {ω}_{N}^{( 2 r + 1 ) j} + {\sum }_{j = 0}^{N / 2 - 1} {f}_{j + N / 2} {ω}_{N}^{( 2 r + 1 ) ( j + N / 2 )} \\ = {\sum }_{j = 0}^{N / 2 - 1} {f}_{j} {ω}_{N / 2}^{rj} {ω}_{N}^{j} - {\sum }_{j = 0}^{N / 2 - 1} {f}_{j + N / 2} {ω}_{N / 2}^{rj} {ω}_{N}^{j} \\ = {\sum }_{j = 0}^{N / 2 - 1} \{ ( {f}_{j} - {f}_{j + N / 2} ) {ω}_{N}^{j} \} {ω}_{N / 2}^{rj} \\ = {DFT}_{r}^{( N / 2 )} ( h )\end{matrix}$$

However for vector f=(fo) with component number 1, however, DFT₀⁽¹⁾ (f)=f₀.

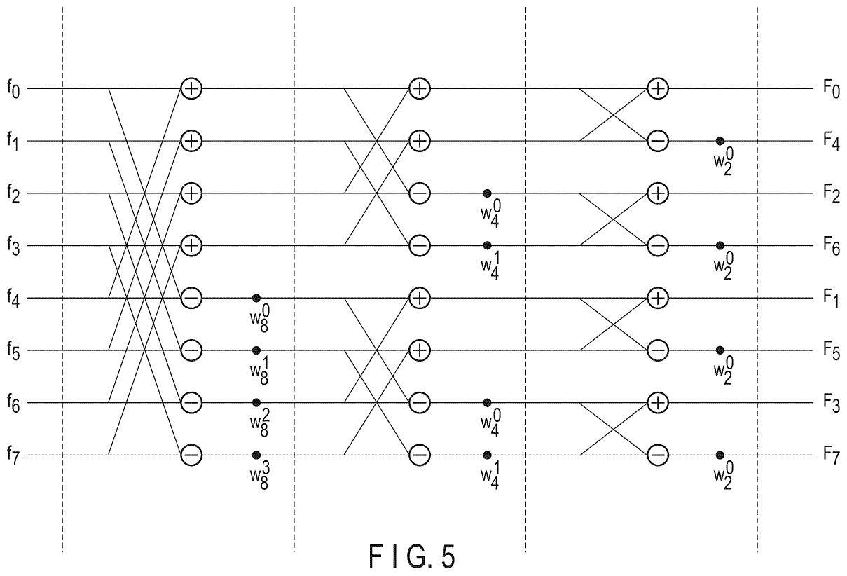

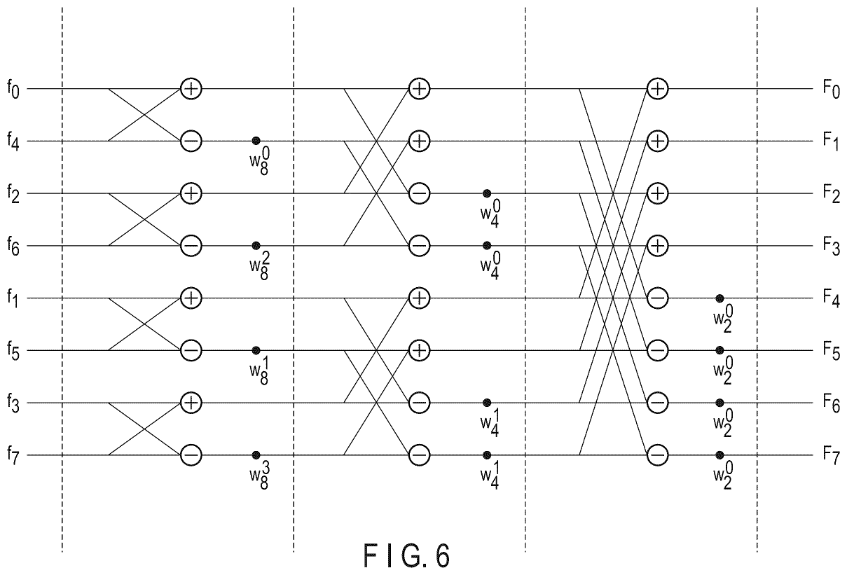

Two types of configurations of the FFT using the GS butterfly operation are shown in FIG. 5 and FIG. 6. FIG. 5 illustrates a first example of the processing flow of fast Fourier transform using the GS butterfly operation. FIG. 6 illustrates a second example of the processing flow of fast Fourier transform using the GS butterfly operation. In the FFT of FIG. 5, the input indices are arranged in natural order and the output indices are arranged in bit-reversed order. In contrast, in the FFT of FIG. 6, the input indices are arranged in bit-reversed order and the output indices are arranged in natural order.

When FFT and IFFT are realized using only one of the configurations in FIG. 3 to FIG. 6, a bit-reversal process is separately required to return either the input indices or the output indices in the bit-reversed order to those in the natural order. In contrast when a configuration in which the output indices are arranged in the bit-reversed order (FIG. 4 or FIG. 5) is used for FFT and a configuration in which the input indexes are arranged in the bit-reversed order (FIG. 3 or FIG. 6) is used for IFFT, the bit-reversal process is not requested.

In addition, for example, the NTT preprocessing and the INTT post-processing other than the process of multiplying by 1/N can also be omitted by including an NTT twiddle factor vector and an INTT twiddle factor vector in a DFT twiddle factor vector and an IDFT twiddle factor vector, respectively. In this case, NTT is defined as follows.

$${NTT}_{i}^{( N )} ( f ) {=}^{Δ} \{ \begin{matrix}{f}_{0} & for N = 1 \\ {NTT}_{i}^{( N / 2 )} ( {f}_{even} ) + {ϕ}_{N} {ω}_{N}^{i} {NTT}_{i}^{( N / 2 )} ( {f}_{odd} ) & for 0 \leq i < \frac{N}{2} , N > 2 \\ {NTT}_{i}^{( N / 2 )} ( {f}_{even} ) - {ϕ}_{N} {ω}_{N}^{i - N / 2} {NTT}_{i}^{( N / 2 )} ( {f}_{odd} ) & for N / 2 \leq i < N , N > 2\end{matrix} \qquad ( 8 )$$

$${INTT}_{i}^{( N )} ( F ) {=}^{Δ} \{ \begin{matrix}{F}_{0} & for N = 1 \\ {INTT}_{i / 2}^{( N / 2 )} & ( {g}_{NTT} ) \\ for i = 2 r , 0 \leq r < N / 2 , N > & 0 \leq j < N / 2 \\ 2 , {g}_{NTT} = ( {F}_{j} + {F}_{j + N / 2} ) & \\ {INTT}_{i / 2}^{( N / 2 )} & ( {h}_{NTT} ) \\ for i = 2 r + 1 , 0 \leq r < N / 2 , N > & 0 \leq j < N / 2 \\ 2 , {h}_{NTT} = ( ( {F}_{j} - {F}_{j + N / 2} ) {ϕ}_{N}^{- 1} {ω}_{N}^{j} ) & \end{matrix} \qquad ( 9 )$$

Equations (8) and (9) can be applied to the computation equation for polynomial multiplication using NTT in Equation (2) but, even in this case, the process of multiplying the computation result of INTT by 1/N is required for each polynomial multiplication.

In order to enable computations between polynomial ring vectors to be performed efficiently, it is necessary to accelerate the inner product operation between polynomial ring vectors using the number theory transform. For this reason, in the present embodiment, when the inner product operation of two polynomial ring vectors using the polynomial x^{N}+1 as the ideal is performed and each component polynomial of one of the polynomial ring vectors is represented by a linear sum of one or more constant polynomials, the frequency domain constant polynomial, which is NTT-transformed by multiplying each constant polynomial by 1/N, is computed in advance, and the inner product operation is accelerated using the frequency domain constant polynomial computed in advance.

In the present embodiment, a polynomial ring vector inner product computation circuit which computes the inner product between a first polynomial ring vector and a second polynomial ring vector, where each component of at least the first polynomial ring vector, of the first polynomial ring vector and the second polynomial ring vector over an integer coefficient polynomial ring using the polynomial X^{N}+1 as the ideal, is a linear sum of one or more constant polynomials, will be described as an example of an operation process involving inner product between polynomial ring vectors using number theoretic transform.

In addition, a computation process of inputting and outputting the polynomial ring vectors of a TRGSW sample, a TRLWE sample, and the like by Controlled Mux (CMux) function, using Torus Fully Homomorphic Encryption (TFHE), will be described as a specific example of an operation process including the inner product between polynomial ring vectors using the number theoretic transform. In the present embodiment, the computation processing circuit performing this computation process is configured to input a first TRLWE sample, which is a cipher text of Torus Fully Homomorphic Encryption (TFHE) obtained by encrypting a first plain text, a second TRLWE sample, which is a cipher text of the TFHE obtained by encrypting a second plain text, and a frequency domain TRGSW sample, which is a cipher text of the TFHE obtained by encrypting 0 or 1, to output a third TRLWE sample, which is a cipher text of the TFHE obtained by encrypting the first plain text when the frequency domain TRGSW sample is the cipher text obtained by encrypting 0, and to output the third TRLWE sample, which is a cipher text of the TFHE obtained by encrypting the second plain text when the frequency domain TRGSW sample is the cipher text obtained by encrypting 1.

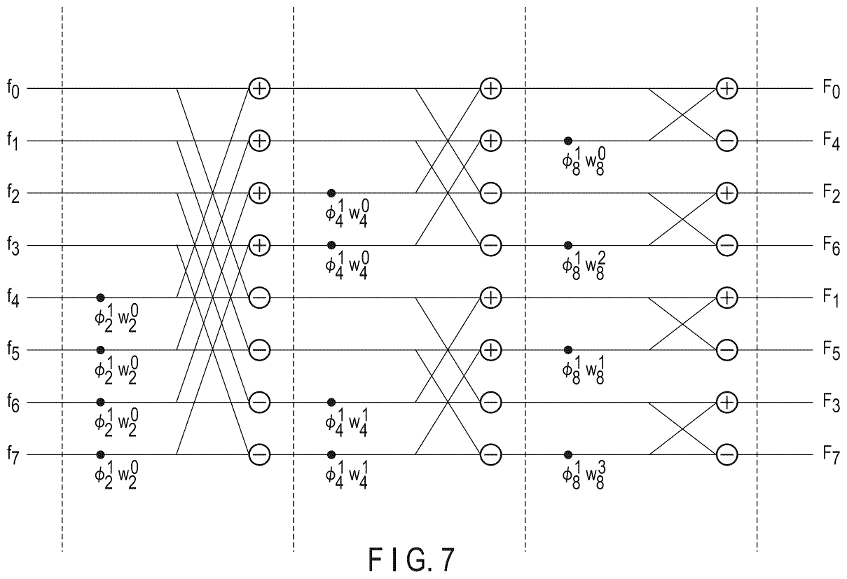

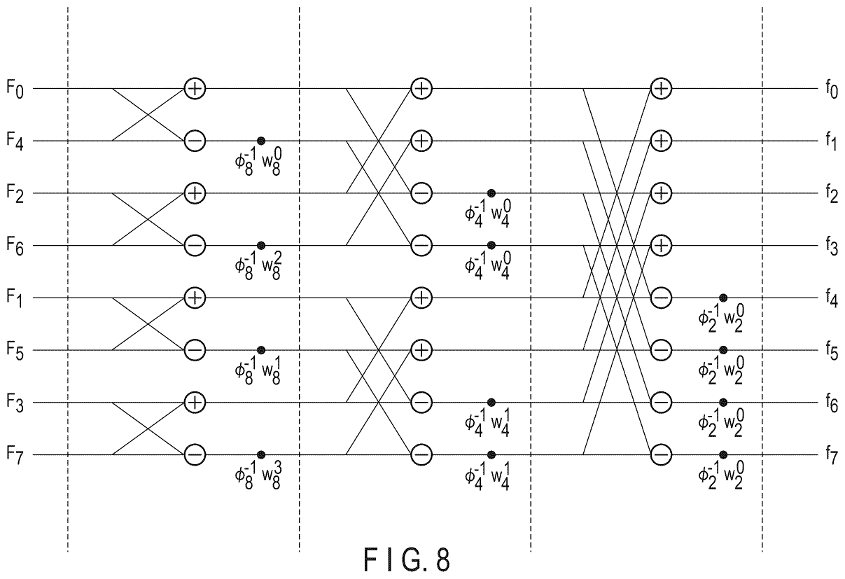

FIG. 7 and FIG. 8 show the processing flows of NTT and INTT defined by Equations (8) and (9), respectively. FIG. 7 illustrates the processing flow of NTT. FIG. 8 illustrates the processing flow of INTT. The processing flows in FIG. 7 and FIG. 8 are composed of combination of the CT butterfly operation and the GS butterfly operation, respectively. Since the output indices are arranged in the bit-reversed order in FIG. 7 and the input indices are arranged in the bit-reversed order in FIG. 8, the above-described bit reverse process is unnecessary. Incidentally, 8-point number theoretic transform (8 inputs and 8 outputs) and 8-point inverse number theoretic transform (8 inputs and 8 outputs) are shown in the processing flows of FIG. 7 and FIG. 8, respectively.

CMux function is a function inputting TRGSW sample C=(Cᵢ) 0≤i<(k+1) l∈(T_{N}[X]^{k+1})^{(k+1)l}, and TRLWE sample d0, d₁∈T_{N}[x]^{k}1, and outputting TRLWE sample, and is defined by Equation (10).

$$\begin{matrix}CMux ( C , {d}_{0} , {d}_{1} ) {=}^{Δ} C ( {d}_{1} - {d}_{0} ) + {d}_{0} \\ = {Dec}_{H} ( {d}_{1} - {d}_{0} ) \cdot C + {d}_{0} \\ = {\sum }_{i = 0}^{( k + 1 ) 1 - 1} {u}_{i} \cdot {C}_{i} + {d}_{0}\end{matrix} \qquad ( 10 )$$

A [symbol] B represents the outer product between vector A and vector B, which is A [symbol] B [symbol] Dec_{H}(B)·A. Dec_{H}(B)∈R^{(k+1)l}, R [symbol] Z[X]/(x^{N}+1) is a gadget decomposition function that decomposes the polynomial ring vector B=(Bᵢ) 0≤i<k+1∈ [symbol] _{N}[X]^{k+1}. Each of the (k+1) components of the polynomial ring vector B is represented by component polynomial Bᵢ∈ [symbol] _{N}[X] (0≤i<k+1). The polynomial ring vector B′ᵢ decomposed by the gadget decomposition function is a polynomial ring vector of length l where each digit b_{i,j,r} (0≤r<1) obtained by decomposing the coefficients b_{i,j} (0≤j<N) of the component polynomial Bi into B_{g} decimal l digits is the polynomial ring vector with length l. In other words, this polynomial ring vector is represented as

$${{B}^{′}}_{i} = {( {{B}^{′}}_{i , r} )}_{0 \leq r < 1} , {{B}^{′}}_{i , r} = {\sum }_{j = 0}^{N - 1} {b}_{i , j , r} {X}^{j} ∈ R .$$

uᵢ∈R is the i-th element (also referred to as a component) of the vector u=Dec_{H}(d₁−d₀)∈R^{(k+1)l}.

At this time, the inner product Σᵢ₌₀^{(k+1)l-1}uᵢ·Cᵢ [symbol] <u, C> of the polynomial ring vector can be computed using NTT and INTT, as indicated by Equation (11).

$$\begin{matrix}< u , \text{C>} = {\sum }_{i = 0}^{( k + 1 ) 1} INTT ( NTT ( {u}_{i} ) ⊙ NTT ( {C}_{i} ) ) \cdot \frac{1}{N} \\ = INTT ( {\sum }_{i = 0}^{( k + 1 ) 1} NTT ( {u}_{i} ) ⊙ NTT ( {C}_{i} ) \cdot \frac{1}{N} ) \\ = INTT ( {\sum }_{i = 0}^{( k + 1 ) 1} NTT ( {u}_{i} ) ⊙ NTT ( {C}_{i} / N ) )\end{matrix} \qquad ( 11 )$$

When Cᵢ is represented by a linear sum of one or more constant polynomials, some or all of Cᵢ/N and NTT (Cᵢ/N) can be preliminarily computed in Equation (11). Therefore, the computation of multiplying the output of INTT by 1/N in the INTT post-processing at the <u, c> computation in the CMux function is unnecessary. Then, since the computation of NTT (Cᵢ/N) is computed in advance and only the computation of NTT (uᵢ) is executed, the number of times of NTT can be halved.

In TFHE, CMux functions are used in at least (1) the Blind Rotate function in the Gate Bootstrapping (GBS) process and (2) the Blind Rotate function in the Vertical Packing (VP) process.

(1) When the CMux function is used in the GBS process, Cᵢ is the i-th element key BKᵢ of the bootstrapping key BK. When BKᵢ is treated as a fixed polynomial and Cᵢ/N is represented as BKᵢ/N, NTT (Cᵢ/N) can be computed in advance as NTT (BKᵢ/N) or NTT (BKᵢ)/N (and these will be used below as NTT (BKᵢ/N) since they are merely different in order of computation and have the same value).

(2) When the CMux function is used in the VP process, Cᵢ is given as a linear sum of each element of the polynomial ring vector (PrvKSK), which is the key switching key (KSK) for Private Functional Key Switching (to be described below) usually performed in the Circuit Bootstrapping (CBS) process before the VP process. PrvKSK is an abbreviation for Private Functional Key Switching KEY. Since each element key of PrvKSK can be treated as a fixed polynomial, Cᵢ can be treated as a linear sum of constant polynomials.

For this reason, when

$${C}_{i} = - {\sum }_{z = 0}^{p - 1} {\sum }_{q = 0}^{n} {\sum }_{r = 0}^{t - 1} {\tilde{c}}_{q , r}^{( z )} ( {PrvKSK}_{z , q , r} ) ∈ {{𝕋}_{N} [ X ]}^{k + 1} ,$$

Cᵢ/N=−Σ_{z=0}^{p-1}Σ_{q=0}ⁿΣᵣ₌₀^{t-1}\tilde{c}_{q,r}^{(z)}(PrvKSK_{z,q,r}/N) is satisfied. PrvKSK_{z,i,j}/N can be therefore computed preliminarily.

Then, since

$$\begin{matrix}NTT ( {C}_{i} / N ) = NTT ( - {\sum }_{z = 0}^{p - 1} {\sum }_{q = 0}^{n} {\sum }_{r = 0}^{t - 1} {\tilde{c}}_{q , r}^{( z )} ( {PrvKSK}_{z , q , r} / N ) ) \\ = - {\sum }_{z = 0}^{p - 1} {\sum }_{q = 0}^{n} {\sum }_{r = 0}^{t - 1} {\tilde{c}}_{q , r}^{( z )} NTT ( {PrvKSK}_{z , q , r} / N ) \\ = - {\sum }_{z = 0}^{p - 1} {\sum }_{q = 0}^{n} {\sum }_{r = 0}^{t - 1} {\tilde{c}}_{q , r}^{( z )} NTT ( {PrvKSK}_{z , q , r} ) / N\end{matrix}$$

is established, NTT (PrvKSK_{z,g,r}/N) or NTT (PrvKSK_{z,g,r)}/N (since these are different in only sequence of computation and indicate the same value, NTT (PrvKSK_{z,q,r}/N) will be used below) can be computed preliminarily.

Next, a procedure of a key setting process will be described.

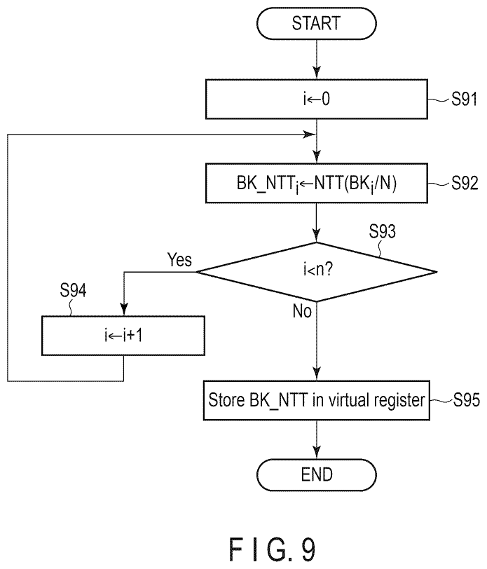

First, the key setting process for bootstrapping keys will be described. FIG. 9 illustrates the key setting process flow for bootstrapping keys. The processing flow in FIG. 9 is corresponding to the preliminary computation of NTT (BKᵢ/N). In FIG. 9, n is the bit length of the encryption key. The preliminary computation of the NTT (BKᵢ/N) is performed by a preliminary computation circuit (also referred to as a frequency domain key preliminary computation circuit) in the present embodiment.

The preliminary computation circuit first sets i to an initial value (step S91). The initial value is, for example, 0.

The preliminary computation circuit computes BKᵢ/N by multiplying the i-th element key BKᵢ of the bootstrapping key BK by 1/N, computes NTT (BKᵢ/N) by applying the number theoretic transform to BKᵢ/N, and sets the computed NTT (BKᵢ/N) as the i-th component of BK_NTT, i.e., BK_NTTᵢ (step S92).

The preliminary computation circuit determines whether or not i is less than n (step S93).

If i is less than n (Yes in step S93), the preliminary computation circuit increments i by 1 (step S94) and returns to step S92.

If i is greater than or equal to n (No in step S93), the preliminary computation circuit stores BK_NTT in a virtual register (step S95) and terminates the key setting process of the bootstrapping key. The entity of the virtual register exists in a memory such as DRAM or SRAM. For this reason, the preliminary computation circuit stores the preliminarily computed BK_NTT in the memory.

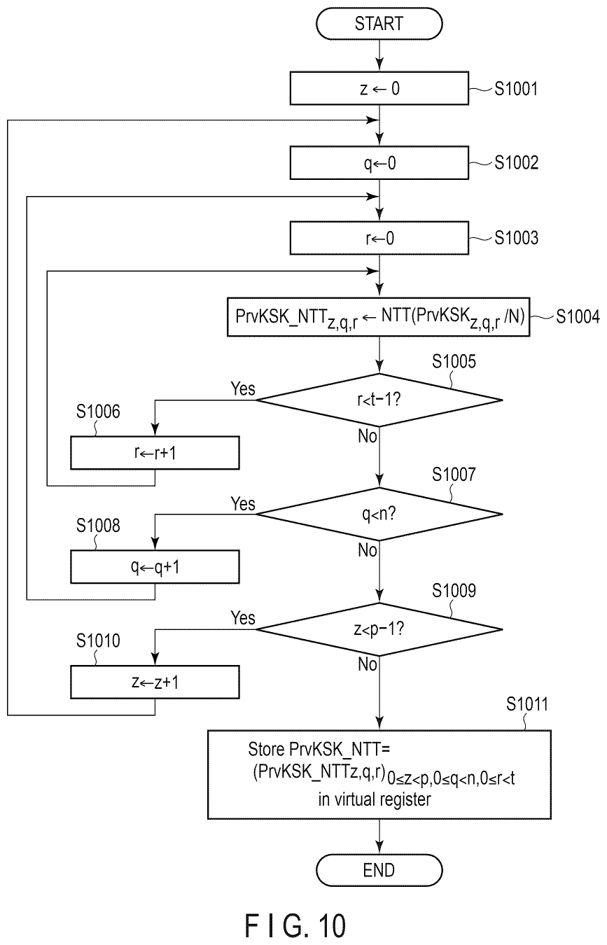

Next, the key setting process for the private functional key switching key will be described. FIG. 10 illustrates the key setting process flow for the private functional key switching key. FIG. 10 corresponds to the preliminary computation of NTT (PrvKSK_{z, q, r}/N). In FIG. 10, p is number of input TRLWE samples in the private functional key switching process, n is bit length of an encryption key, and t is number of digits in a case where each component of the input TRLWE sample is decomposed into binary numbers. The preliminary computation circuit first sets initial values for z, q, and r (steps S1001 to S1003). For example, z, q, and r are set to 0.

The preliminary computation circuit computes PrvKSK_{z, q, r}/N by multiplying the element keys uniquely identified with z, q, and r in the private functional key switching key by 1/N, computes NTT (PrvKSK_{z, q, r}/N) by applying the number theoretic transform to PrvKSK_{z, q, r}/N, and sets the computed NTT (PrvKSK_{z, q, r}/N) as component PrvKSK_NTT_{z, q, r} uniquely identified with z, q, r in PrvKSK_NTT (step S1004).

The preliminary computation circuit determines whether or not r is less than t−1 (step S1005).

If r is less than t−1 (Yes in step S1005), the preliminary computation circuit increments r by 1 (step S1006) and returns to step S1004.

If r is greater than or equal to t−1 (No in step S1005), the preliminary computation circuit determines whether or not q is less than n (step S1007).

If q is less than n (Yes in step S1007), the preliminary computation circuit increments q by 1 (step S1008) and returns to step S1003.

If q is greater than or equal to n (No in step S1007), the preliminary computation circuit determines whether or not z is less than p−1 (step S1009).

If z is less than p−1 (Yes in step S1009), the preliminary computation circuit increments z by 1 (step S1010) and returns to step S1002.

If z is greater than or equal to p−1 (No in step S1009), the preliminary computation circuit stores PrvKSK_NTT having (PrvKSK_NTT_{z, q, r}) 0≤z<p, 0≤q<n, 0≤r<t as the respective components in the virtual register (step 1011), and ends the key setting process for the private functional key switching key. As described above, the entity of the virtual register exists in a memory such as DRAM or SRAM. For this reason, the preliminary computation circuit stores the preliminarily computed PrvKSK_NTT in the memory.

BK_NTT, which is the output of FIG. 9, and PrvKSK_NTT, which is the output of FIG. 10, are stored in different virtual registers (different memory regions in the memory).

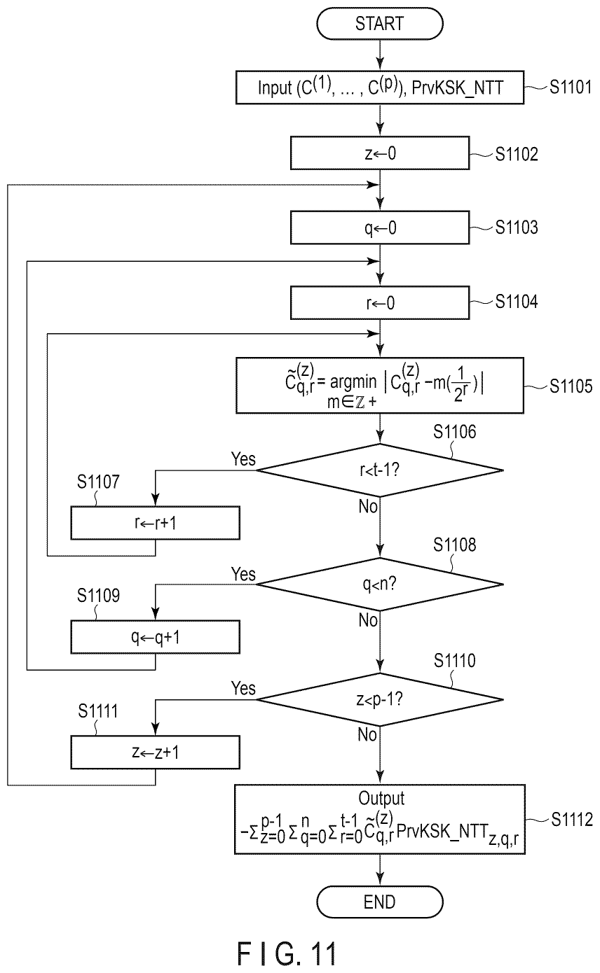

Next, the private functional key switching process will be described. FIG. 11 illustrates a flowchart of the private functional key switching process in the present embodiment.

The preliminary computation circuit inputs (C(1), . . . , C(p)) and PrvKSK_NTT as inputs for the private functional key switching process (step S1101).

The preliminary computation circuit sets initial values for z, q, and r (steps S1101 to S1103). For example, z, q, and r are set to 0.

The preliminary computation circuit uses

$${arg min}_{m ∈ Z +} \vert {C}_{q , r}^{( z )} - m ( \frac{1}{{2}^{r}} ) \vert$$

as element key Č_{q,r}^{(z)} uniquely specified by z, q,r of the switched private functional key switching key (step S1105).

The preliminary computation circuit determines whether or not r is less than t−1 (step S1106).

If r is less than t−1 (Yes in step S1106), the preliminary computation circuit increments r by 1 (step S1107) and returns to step S1105.

If r is greater than or equal to t−1 (No in step S1106), the preliminary computation circuit determines whether or not q is less than n (step S1109).

If q is less than n (Yes in step S1109), the preliminary computation circuit increments q by 1 (step S1109) and returns to step S1104.

If q is greater than or equal to n (No in step S1109), the preliminary computation circuit determines whether or not z is less than p−1 (step S1110).

If z is less than p−1 (Yes in step S1110), the preliminary computation circuit increments z by 1 (step S1111) and returns to step S1103.

If z is greater than or equal to p−1 (No in step S1110), the pre-computation circuit outputs −Σ_{z=0}^{p-1}Σ_{q=0}ⁿΣᵣ₌₀^{t-1}Č_{q, r}^{(z)} PrvKSK_NT_{z, q, r} (step 1112), and ends the key setting process for the private functional key switching key.

This output is stored in the virtual register (memory).

Thus, the private functional key switching process of the present embodiment uses PrvKSK_NTT (=(NTT (PrvKSK_{z, q, r}/N)) 0≤z<p, 0≤q<n+1, 0≤r<t) obtained by multiplying each component of PrvKSK by 1/N and applying NTT is used instead of the private function type key switching key (PrvKSK), and outputs not the polynomial to which NTT is to be applied, but the polynomial to which NTT has been applied.

The polynomials before and after the application of NTT are hereinafter referred to as a time domain polynomial and a frequency-region polynomial, respectively.

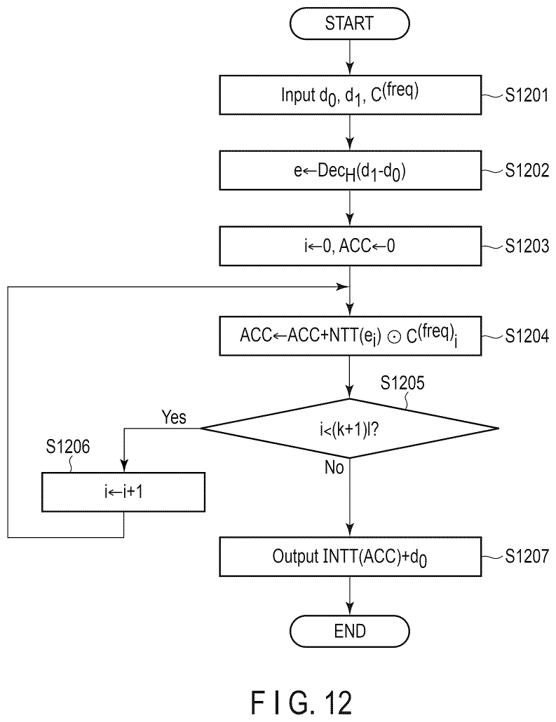

Next, the processing of the CMux function defined in Equation (10) will be described. FIG. 12 is a flowchart illustrating the procedure of the CMux function executed in the embodiment.

The inputs of the CMux function described with reference to FIG. 12 are two TRLWE samples d₀, d₁∈ [symbol] _{N}[X]^{k+1} and one frequency domain TRGSW sample c^{(freq)}∈ [symbol] _{N}[X]k^{(l+1)}, and the output of the CMux function is one TRLWE sample.

The CMux operation circuit first inputs two TRLWE samples d0, d1, and one frequency domain TRGSW sample C(freq) (step S1201). The frequency domain TRGSW sample C(freq) is a first frequency domain polynomial ring vector. The first frequency domain polynomial ring vector has as each component a linear sum of the frequency domain constant polynomials obtained by preliminarily executing a process of multiplying each of one or more constant polynomials, which is a component of the polynomial ring vector over an integer coefficient polynomial ring using polynomial x^{N}+1 as the ideal, by 1/N and a process of applying the number theoretic transform to each of one or more constant polynomials multiplied by 1/N. The first frequency domain polynomial ring vector is preliminarily computed and stored in the virtual register (memory). Therefore, in step S1201, the computation processing circuit reads C(freq) (i.e., the first frequency domain polynomial ring vector) from the virtual register (memory). The CMux operation circuit refers to gadget decomposition function DecH(d1−d0) as e (step S1202).

The CMux operation circuit sets initial values for i and ACC, which is a cumulative value of products of the components (step S1203). For example, i and ACC are set to 0.

The CMux operation circuit adds a product between NTT(ei), which is obtained by applying the number theoretic transform to the i-th component of e, and the i-th element of C(freq) i read from the virtual register (memory) to ACC (step S1204). As for the NTT function in step S1204, the function defined in Equation (8) is used.

The CMux operation circuit determines whether or not i is less than (k+1)l (step S1205).

If i is less than (k+1)l (Yes in step S1205), the CMux operation circuit increments i by 1.

If i is greater than or equal to (k+1)l (No in S1205), the CMux operation circuit outputs a sum of INTT (ACC) obtained by applying the inverse number theoretic transform to ACC, and d0. As for the INTT function in step S1206, the function defined by Equation (9) is used.

When the CMux function is used in the GBS process, c^{(freq)} is NTT (BKᵢ/N), and when the CMux function is used in the VP process, C^{(freq)} is the output −Σ_{z=0}^{p-1}Σ_{q=0}ⁿΣᵣ₌₀^{t-1}\tilde{c}_{q,r}^{(z)} (PrvKSK_NTT_{z, q, r}) of the private functional key switching process in FIG. 11.

In a loop of steps S1204, S1205, and S1207, the Hadamard product between the two vectors, i.e., NTT(e) and C^{(freq)}, is computed, and a first inner product (Hadamard inner product), which is a frequency component polynomial, is computed by calculating the sum of the components of the Hadamard product. This first inner product is also referred to as an Hadamard inner product between two vectors, i.e., NTT(e) and C^{(freq)}. The computation of this Hadamard inner product is performed by the polynomial ring vector inner product computation circuit contained within the CMux operation circuit.

Next, an example of a configuration of the CMux operation circuit will be described.

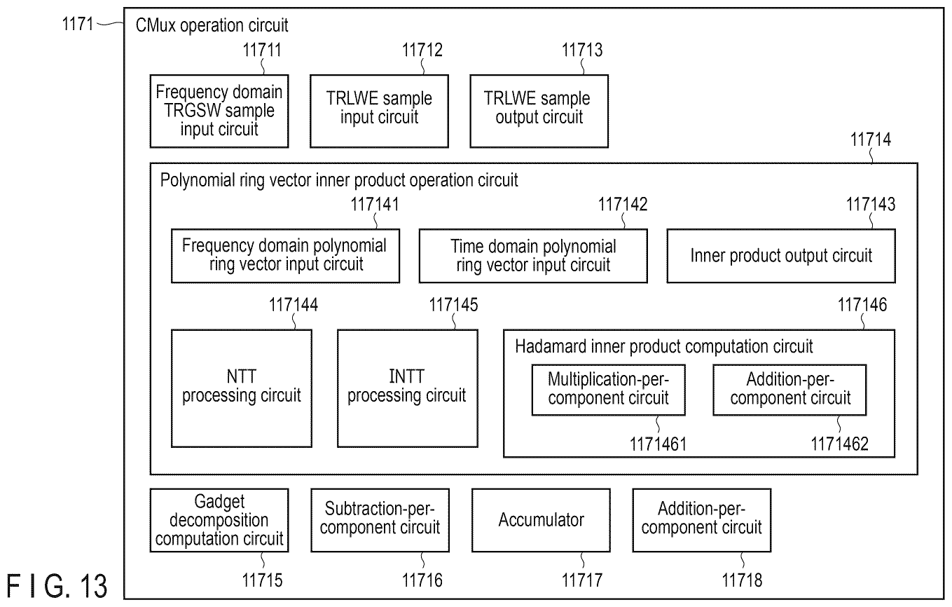

FIG. 13 illustrates the configuration of the CMux operation circuit that executes the processing of the CMux function in the present embodiment. A CMux operation circuit 1171 executes, for example, the processing of the CMux function described above with reference to FIG. 12. In other words, the CMux operation circuit 1171 operates as a computation processing circuit configured to input a first TRLWE sample, which is a cipher text of TFHE obtained by encrypting a first plain text, a second TRLWE sample, which is a cipher text of the TFHE obtained by encrypting a second plain text, and a frequency domain TRGSW sample, which is a cipher text of the TFHE obtained by encrypting 0 or 1, to output a third TRLWE sample, which is a cipher text of the TFHE obtained by encrypting the first plain text when the frequency domain TRGSW sample is the cipher text obtained by encrypting 0, and to output the third TRLWE sample, which is a cipher text of the TFHE obtained by encrypting the second plain text when the frequency domain TRGSW sample is the cipher text obtained by encrypting 1. The CMux operation circuit 1171 includes a frequency domain TRGSW sample input circuit 11711, a TRLWE sample input circuit 11712, a TRLWE sample output circuit 11713, a polynomial ring vector inner product operation circuit 11714, a gadget decomposition computation circuit 11715, a subtraction-per-component circuit 11716, an accumulator 11717, and an addition-per-component circuit 11718.

The frequency domain TRGSW sample input circuit 11711 is a circuit that inputs frequency domain TRGSW samples used in the processing of the CMux function. The frequency domain TRGSW sample input circuit 11711 executes the input of C^{(freq)} in step S1201 of FIG. 12. The frequency domain TRGSW sample input circuit 11711 reads the frequency domain TRGSW sample (in this case, C^{(freq)}) from the virtual register (memory) and inputs the read C^{(freq)} as a control input for the CMux function. In other words, since C^{(freq)} preliminarily computed by the preliminary computation circuit is stored in the memory as the frequency domain TRGSW sample as described above, the frequency domain TRGSW sample input circuit 11711 reads C^{(freq)} from the memory. This C^{(freq)} is used as the control input for the CMux function.

Incidentally, if the CMux operation circuit 1171 is included in an accelerator included in a computing storage device configured to execute communication with a host based on the NVM Express™ standard, the preliminary computation circuitry and the memory may be included in the accelerator.

In addition, the preliminary computation of C^{(freq)} may be executed by the host instead of executing the preliminary computation of C^{(freq)} in the preliminary computation circuit in the accelerator. In this case, C^{(freq)} preliminarily computed in the host is received from the host by the accelerator, and the received C^{(freq)} is stored in the memory by the accelerator. Thus, C^{(freq)} preliminarily computed in the host and received from the host is stored in the memory. Therefore, the frequency domain TRGSW sample input circuit 11711 can execute computations between the polynomial ring vectors, using C^{(freq)} read from the memory by the accelerator. The preliminary computation executed by the host may be both or one of the NTT computation and multiplying by 1/N. If the preliminary computation is one of the NTT computation and multiplying by 1/N, then the accelerator completes the preliminary computation of C^{(freq)} by preliminarily executing the other computation on the preliminary computation value received from the host.

The C^{(freq)} preliminarily computed by the preliminary computation circuit (or the host) is the cipher text data of TFHE, for example, the bootstrapping key or private functional key switching key, which is subjected to the number theoretic transform. In other words, C^{(freq)} is the first frequency domain polynomial ring vector having as each component a linear sum of one or more frequency domain constant polynomials obtained by preliminarily executing the process of multiplying each of one or more constant polynomials, which is a component of the bootstrapping key (or private functional key switching key), i.e., the polynomial ring vector over the integer coefficient polynomial ring using polynomial x^{N}+1 as the ideal, by 1/N, and the process of applying the number theoretic transform.

The TRLWE sample input circuit 11712 is a circuit of inputting the TRLWE samples used for the processing of the CMux function. The TRLWE sample input circuit 11712 inputs d0 and d1 in step S1201 of FIG. 12 as two data inputs of the CMux function. d0 is the first TRLWE sample, which is the cipher text of TFHE obtained by encrypting the first plain text, and d1 is the second TRLWE sample, which is the cipher text of TFHE obtained by encrypting the second plain text.

The TRLWE sample output circuit 11713 is a circuit which outputs the TRLWE samples generated in the processing of the CMux function as the output data of the CMux function. The TRLWE sample output circuit 11713 outputs INTT (ACC)+d0 in step S1207 of FIG. 12 as the output data of the CMux function. INTT (ACC)+d0 is the result of the processing of the CMux function. The TRLWE sample output from the TRLWE sample output circuit 11713 as the output data of the CMux function is also referred to as the third TRLWE sample.

The polynomial ring vector inner product operation circuit 11714 is a circuit configured to compute the inner product between two polynomial ring vectors. The polynomial ring vector inner product operation circuit 11714 operates as a polynomial ring vector inner product computation circuit that computes the inner product between the first polynomial ring vector and the second polynomial ring vector over the integer coefficient polynomial ring using polynomial x^{N}+1 as an ideal. In this case, each component of at least the first polynomial ring vector, of the first polynomial ring vector and the second polynomial ring vector, is a linear sum of one or more constant polynomials.

The subtraction-per-component circuit 11716 is a circuit that calculates a difference between two polynomials. For example, the subtraction-per-component circuit 11716 computes a fourth TRLWE sample obtained by subtracting each component of the first TRLWE sample from each component of the second TRLWE sample. More specifically, the subtraction-per-component circuit 11716 executes the computation of the difference d1−d0 between two polynomials in step S1202 of FIG. 12.

The gadget decomposition computation circuit 11715 is a circuit that executes the computation of the gadget decomposition function.

The gadget decomposition computation circuit 11715 computes the value of the gadget decomposition function Dec_{H} in step S1202 of FIG. 12.

The gadget decomposition computation circuit 11715 computes the integer coefficient polynomial ring vector obtained by gadget decomposing the fourth TRLWE sample. For example, if d1−d0 is computed as the fourth TRLWE sample, the gadget decomposition computation circuit 11715 computes the integer coefficient polynomial ring vector obtained by executing gadget decomposition of d1−d0.

The accumulator 11717 is a memory that stores ACC values computed in step S1204 of FIG. 12. The accumulator may be a virtual register.

The addition-per-component circuit 11718 is a circuit that calculates a sum of two polynomials. The addition-per-component circuit 11718 is a circuit that adds each component of the first TRLWE sample d0 to each component of the time-domain polynomial INTT (ACC) computed by the polynomial ring vector inner product operation circuit 11714. More specifically, the addition-per-component circuit 11718 executes the computation of the sum of INTT (ACC) and d0 in step S1207 of FIG. 12. In this case, the addition-per-component circuit 11718 adds each component of d0 to each component of INTT (ACC). The INTT (ACC)+d0 obtained by the addition-per-component circuit 11718 is output as the third TRLWE sample by the TRLWE sample output circuit 11713.

In this case, the content of the INTT (ACC)+d0, which is the third TRLWE sample, is a cipher text determined by the value of C^{(freq)} and obtained by encrypting either the first plain text or the second plain text. In other words, if the frequency domain TRGSW sample is encrypted 0, then INTT (ACC)+d0 is a cipher text obtained by encrypting the first plain text. If the frequency domain TRGSW sample is encrypted 1, then INTT (ACC)+d0 is a cipher text obtained by encrypting the second plain text.

Next, an internal configuration of the polynomial ring vector inner product operation circuit 11714 will be described. The polynomial ring vector inner product operation circuit 11714 includes a frequency domain polynomial ring vector input circuit 117141, a time domain polynomial ring vector input circuit 117142, an inner product output circuit 117143, an NTT processing circuit 117144, an INTT processing circuit 117145, and an Hadamard inner product computation circuit 117146.

The frequency domain polynomial ring vector input circuit 117141 is a circuit that inputs the frequency domain polynomial ring vector subjected to the inverse number theoretic transform to the INTT processing circuit 117145. The frequency domain polynomial ring vector subjected to the inverse number theoretic transform is, for example, the ACC in step S1207 of FIG. 12.

The time domain polynomial ring vector input circuit 117142 is a circuit that inputs the time domain polynomial ring vector subjected to the number theoretic transform to the NTT processing circuit 117144. The time domain polynomial ring vector subjected to the number theoretic transform is, for example, e in step S1204 of FIG. 12.

The inner product output circuit 117143 is a circuit that outputs the inner product between two polynomial ring vectors. For example, the inner product output circuit 117143 outputs the ACC calculated in steps S1204 through S1206 of FIG. 12. The NTT processing circuit 117144 is a circuit that executes the number theoretic transform (NTT) process. For example, the NTT processing circuit 117144 executes computation of NTT(eᵢ) in step S1204 of FIG. 12.

The INTT processing circuit 117145 is a circuit that executes the inverse number theoretic transform (INTT) process. For example, the INTT processing circuit 117145 computes the INTT in step S1206 of FIG. 12.

The Hadamard inner product computation circuit 117146 is a circuit that computes the Hadamard product between two polynomial ring vectors and the inner product (Hadamard inner product) of two polynomial ring vectors. The Hadamard inner product is the sum of the components of the Hadamard product. The Hadamard inner product computation circuit 117146 includes a multiplication-per-component circuit 1171461 and an addition-per-component circuit 1171462.

The multiplication-per-component circuit 1171461 is a circuit which computes the product of each component of two polynomial ring vectors and the Hadamard product. The multiplication-per-component circuit 1171461 computes, for example, the Hadamard product (operator ⊙) of two polynomial ring vectors NTT(e) and C^{(freq)} in step S1204 of FIG. 12.

The addition per component circuit 1171462 is a circuit that computes the inner product (Hadamard inner product) of two polynomial ring vectors. For example, the addition-per-component circuit 1171462 computes the sum of the components of the Hadamard product between the two polynomials NTT(e) and C^{(freq)} in step S1204 of FIG. 12.

Thus, when computing the inner product between two polynomial ring vectors, the polynomial ring vector inner product operation circuit 11714 computes an Hadamard product between a first frequency domain polynomial ring vector and a second frequency domain polynomial ring vector which is obtained by applying the NTT to each component of the polynomial ring vector, based on the first frequency domain polynomial ring vector computed in advance, computes a first product by computing a sum of the components of the computed Hadamard product, and outputs the time domain polynomial obtained by applying the INTT to the first inner product. In other words, the polynomial ring vector inner product operation circuit 11714 computes the Hadamard inner product between the first frequency domain polynomial ring vector and the second frequency domain polynomial ring vector as the above-described first inner product, based on the first frequency domain polynomial ring vector computed in advance.

Since the first frequency domain polynomial ring vector is computed in advance, the polynomial ring vector inner product operation circuit 11714 can skip the process of multiplying each component of one polynomial ring vector by 1/N and the process of applying the NTT process to each component of one polynomial ring vector, which are required for obtaining the first frequency domain polynomial ring vector, when computing the inner product between the two polynomial ring vectors. In other words, when computing the inner product between two polynomial ring vectors, the polynomial ring vector inner product operation circuit 11714 can eliminate the process of multiplying by 1/N and halve the number of times of executing the NTT process. However, the NTT process of computing the second frequency domain polynomial ring vector is necessary.

Accordingly, the CMux operation circuit 1171 executing the CMux operation including the process of computing the inner product between two polynomial ring vectors, can also eliminate the process of multiplying by 1/N and halve the number of times of executing the NTT process, for the computation required for the CMux function. The CMux operation circuit 1171 can therefore reduce the amount of computation and the time, which are required for the computation of the CMux function. In other words, the CMux operation circuit 1171 can efficiently execute the computation of the encrypted data for which the polynomial ring vector is used.

Next, the configuration of the accelerator including the CMux operation circuit 1171 of FIG. 13 will be described.

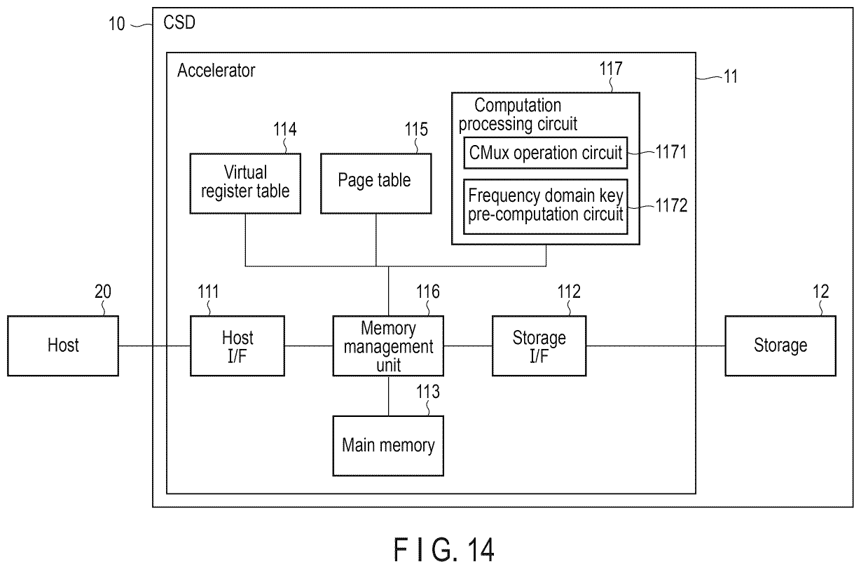

FIG. 14 is a block diagram illustrating an example of a configuration of a computing storage device (hereinafter referred to as CSD) in the present embodiment. A CSD 10 shown in FIG. 14 corresponds to, for example, a storage device having an ability to process a computing instruction and is also referred to as a memory system.

The CSD 10 is configured to be connectable to a host 20 and comprises an accelerator 11 and a storage 12.

The accelerator 11 is a device that operates to increase the processing speed of the computer system (the CSD 10 and the host 20) and corresponds to a controller that controls the CSD 10. As shown in FIG. 14, the accelerator 11 comprises a host interface (I/F) 111, a storage interface (I/F) 112, a main memory 113, a virtual register table 114, a page table 115, a memory management unit 116, and a computation processing circuit 117.

The host interface 111 receives computing storage I/O commands (hereinafter referred to as I/O commands) specifying host data from the host 20. The I/O commands include read commands for reading the data from the storage 12 and write commands for writing the data into the storage 12. Examples of the host data specified by the I/O commands include the read data to be read from the storage 12 and the write data to be written to the storage 12, based on the I/O commands (read commands and write commands). The host data associated with the I/O command is specified by a logical address. The logical address is an address used by the host 20 to access the storage 12 (i.e., to read the data from the storage 12 and write the data into the storage 12). The host interface 111 transmits and receives the host data to and from the host 20. The storage interface 112 transmits and

receives the host data to and from the storage 12. In other words, when the host data is the read data, the storage interface 112 receives the read data from the storage 12. Alternatively, when the host data is the write data, the storage interface 112 transmits the write data to the storage 12. In addition, the storage interface 112 transmits to the storage 12 commands to control the operation of the storage 12.

The main memory 113 is the above-described memory and is used to temporarily store a copy of the host data specified by the I/O commands (i.e., data read and written by the I/O commands). The main memory 113 is configured to be accessible faster than the storage 12 and is realized by, for example, a volatile memory such as DRAM provided in the CSD 10. In addition, a part of the storage area of the main memory 113 is used as a virtual register group. Each virtual register in the virtual register group is used to store the data used to process computation instructions according to computation options associated with the host data specified by the I/O commands.

The virtual register table 114 manages the address information necessary to access individual virtual registers in the main memory 113. More specifically, the virtual register table 114 stores a virtual address and the data size of the data in association with each of the virtual register numbers specified (computed) based on the computation options. The virtual address is represented by the page number and the page offset these are assigned to the page on which the data used to process the computation instructions according to the computation options is stored.

The page table 115 is a table for managing whether the storage destination of the data in the page is the main memory 113 or the storage 12, for each of the page numbers. More specifically, the page table 115 stores a flag indicative of the data storage destination and an actual address of the storage destination, in association with each of the page numbers.

The memory management unit 116 executes a process of storing a copy of the host data specified by the I/O command in the main memory 113 with reference to the page table 115 and updating the virtual register table 114, in accordance with the operation mode of the CSD 10. The operation modes of the CSD 10 include Copy with Read (CwR) mode, Copy with Write (CwW) mode, Compute on Read (CoR) mode, and Compute on Write (CoW) mode.

The CwR mode is the operation mode for copying the host data (read data) specified by the read command from the host 20, to the main memory 113.

The CwW mode is the operation mode for copying the host data (write data) specified by the write command from the host 20, to the main memory 113.

The CoR mode is the operation mode for processing the computation instructions using the host data (read data) specified by the read command from the host 20.

The CoW mode is the operation mode for processing the computation instructions using the host data (write data) specified by the write command from the host 20.

The computation processing circuit 117 processes the computation instructions according to the computation options associated with the host data specified by the I/O commands (i.e., the computation instructions using the host data), by referring to the virtual register table 114. The computation processing circuit 117 further includes the CMux operation circuit 1171 described with reference to FIG. 13 and a frequency domain key pre-computation circuit 1172 that executes the key setting processing flow described with reference to FIG. 9 and FIG. 10. The frequency domain key pre-computation circuit 1172 computes frequency domain keys having in each component a linear sum of one or more frequency domain constant polynomials obtained by preliminarily executing a process of multiplying each of one or more constant polynomials by 1/N and a process of executing an NTT on each of one or more constant polynomials multiplied by 1/N. The frequency domain keys (BK_NTT and PrvKSK_NTT) computed by the frequency domain key pre-computation circuit 1172 are stored in the main memory 113. When the key setting process flow shown in FIG. 9 and FIG. 10 is executed outside of the accelerator 11 (for example, when the host 20 executes the key setting process flow and the accelerator 11 receives the frequency domain key from the host 20), the process in which the frequency domain key pre-computation circuit 1172 executes the key setting process is unnecessary.

A plurality of processing circuits including each circuit in the CMux operation circuit 1171 and the frequency domain key pre-computation circuit 1172 may be distributed in a plurality of accelerators 11 connected through the network. In such a configuration, when the plurality of accelerators 11 are associated to operate, a plurality of processing circuits that are arranged in the plurality of accelerators 11 respectively can execute the computation processes in parallel.

Next, an example of an instruction set of secure computation instructions used by the accelerators 11 will be described.

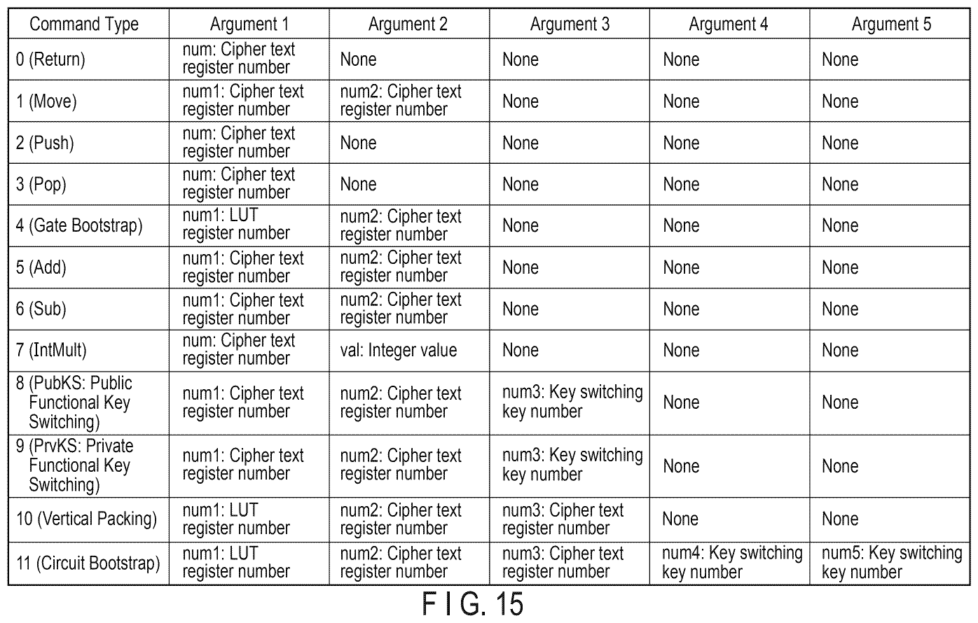

FIG. 15 illustrates an example of the instruction set of secure computation instructions used by the accelerators 11 according to the present embodiment. In the example shown in FIG. 15, the instruction set of secure computation instructions includes Return instruction, Move instruction, Push instruction, Pop instruction, Gate Bootstrap instruction, Add instruction, Sub instruction, IntMult instruction, PubKS (Public Functional Key Switching) instruction, PrvKS (Private Functional Key Switching) instruction, Vertical Packing instruction, and Circuit Bootstrap instruction, which are represented by command types 0 to 11. In FIG. 15, for convenience, the virtual register numbers for referring to the cipher text registers are shown as cipher text register numbers, and the virtual register numbers for referring to the Look Up Table (LUT) registers are shown as LUT register numbers.

The Return instruction corresponds to command type 0. The Return instruction takes cipher text register number num as its argument. According to the Return instruction, the value of the cipher text register referred to by the cipher text register number num is transmitted to the host 20 or the storage 12. Incidentally, the value of the cipher text register is transmitted to the host 20 if the cipher text register is a CoR register or transmitted to the storage 12 if the cipher text register is a CoW register. After the value of the cipher text register is transmitted, the stack pointer to manage the reference location of the stack region included in the virtual address space is set to 0.

The Move instruction is an instruction corresponding to command type 1. The Move instruction takes the cipher text register numbers num1 and num2 as arguments. According to the Move instruction, the value of the cipher text register referenced by the cipher text register number num1 is copied to the cipher text register referenced by the cipher text register number num2.

The Push instruction is an instruction corresponding to command type 2. The Push instruction takes the cipher text register number num as its argument. According to the Push instruction, the value of the cipher text register referenced by the cipher text register number num is copied to the leading part of the stack region included in the virtual address space, and the stack pointer is decremented (i.e., subtracting the value of the stack pointer by 1).

The Pop instruction is an instruction corresponding to command type 3. The Pop instruction takes the cipher text register number num as its argument. According to the Pop instruction, the leading value of the stack region in the virtual address space is copied to the cipher text register referenced by the cipher text register number num, and the stack pointer is incremented (i.e., adding the value of the stack pointer to 1).

The Gate Bootstrap instruction is an instruction corresponding to command type 4. The Gate Bootstrap instruction takes the LUT register number num1 and cipher text register number num2 as arguments. According to the Gate Bootstrap instruction, GBS or Programmable Bootstrapping (PBS) is executed for the value of the cipher text register referenced by cipher text register number num2, by using the LUT register referenced by the LUT register number num1. For example, GBS is executed when LUT register number num1=0 or PBS is executed when LUT register number num1>0. The execution result (output value) of the GBS or PBS is copied to the cipher text register referenced by the cipher text register number num2. For example, if the value of the LUT register referenced by the LUT register number num1 is the LUT for function f(x) and the value of the cipher text register referenced by the cipher text register number num2 before executing the Bootstrap instruction is the TLWE sample for x, the value of the cipher text register referenced by the cipher text register number num2 after executing the Bootstrap instruction is the TLWE sample for f(x). The CMux function is used in the Blind Rotate process executed in the Bootstrap instruction.

The Add instruction is an instruction corresponding to command type 5. The Add instruction takes cipher text register numbers num1 and num2 as arguments. According to the Add instruction, the value of the cipher text register referenced by the cipher text register number num1 and the value of the cipher text register referenced by the cipher text register number num2 are added for each component, and the addition result (computation result) is copied to the cipher text register referenced by the cipher text register number num1.

The Sub instruction is an instruction corresponding to command type 6. The Sub instruction takes the cipher text register numbers num1 and num2 as arguments. According to the Sub instruction, the value of the cipher text register referenced by the cipher text register number num2 is subtracted from the value of the cipher text register referenced by the cipher text register number num1, for each component, and the subtraction result (computation result) is copied to the cipher text register referenced by the cipher text register number num1.

The IntMult instruction is an instruction corresponding to command type 7. The IntMult instruction takes the cipher text register number num and the integer value val as arguments. According to the IntMult instruction, the value of the cipher text register referenced by the cipher text register number num is multiplied by the integer value val, for each component, and the multiplication result (computation result) is copied to the cipher text register referenced by the cipher text register number num.

The PubKS instruction is an instruction corresponding to command type 8. The PubKS instruction takes the cipher text register numbers num1 and num2 and the key switching key number num3 as arguments. Incidentally, the key switching key number in the PubKS instruction is a virtual register number for referring to the PubKS Key (PubKS) register. According to the PubKS instruction, public functional key switching using the key switching key stored in the PubKSK register referenced by the key switching key number num3 is executed for the value of the cipher text register (i.e., the cipher text) referenced by the cipher text register number num1, and the cipher text to which the public functional key switching has been applied is stored in the cipher text register referenced by the cipher text register number num2. Incidentally, the function in the PubKS instruction is assumed to be, for example, an identity function (f(x)=x).

The PrvKS instruction is an instruction corresponding to command type 9. The PrvKS instruction takes the cipher text register numbers num1 and num2 and the key switching key number num3 as arguments. Incidentally, the key switching key number in the PrvKS instruction is a virtual register number for referring to the PrvKS Key (PrvKS) register. According to the PrvKS instruction, the private functional key switching using the key switching key stored in the PrvKSK register referenced by the key switching key number num3 is executed for the value of the cipher text register (i.e., the cipher text) referenced by the cipher text register number num1, and the cipher text to which the private functional key switching has been applied is stored in the cipher text register referenced by the cipher text register number num2. Incidentally, k+1 key switching keys for Public Functional Key Switching are stored as one key switching key for Private Functional Key Switching, in the PrvKSK register referenced by the key switching key number num3. More specifically, the key switching key stored in the PrvKSK register is the key obtained by encrypting function (f_u(x)=−Ku×x if u≤k, otherwise f_{u}(x)=1×x if u=k+1) for x=k_i/2j (1≤i≤n+1, 1≤j≤t), in each of k+1 TLWE (or TRLWE) samples. If k=1, two keys are counted as one key switching key (PrvKSK) for private functional key switching.

Incidentally, a plurality of PubKSK and PrvKSK registers per cipher text register may exist during the multiparty computation (key switching multiparty computation). For this reason, in the third argument of the PubKS and PrvKS instructions, the key switching key number (virtual register number) to refer to the PubKSK and PrvKSK registers to be used is clearly indicated.

The Vertical Packing instruction is an instruction corresponding to command type 10. The Vertical Packing instruction is an instruction for executing a Vertical Packing algorithm. The Vertical Packing instruction takes the LUT register number num1 and the cipher text register numbers num2 and num3 as arguments. num1 is the virtual register number including s LUT used to compute each output bit of any d-bit input s-bit output function used in VP. num2 is the virtual register number of the cipher text register including d TRGSW samples. num3 is the virtual register number of the cipher text register including s TLWE samples. In the Vertical Packing instruction, s Blind Rotate processes are executed, in which the CMux function is used. In addition, each of s samples output from s Blind Rotate processes is converted into the TLWE sample by the Sample Extract process.

The Circuit Bootstrap instruction is an instruction corresponding to command type 11. The Circuit Bootstrap instruction is an instruction for executing Circuit Bootstrapping. The Circuit Bootstrap instruction takes the LUT register number num1, the cipher text register numbers num2 and num3, and the key switching key numbers num4 and num5 as arguments. num1 is the virtual register number including the LUT used in the CBS. num2 is the virtual register number of the cipher text register including s TLWE samples. num3 is the virtual register number of the cipher text register including s TRGSW samples. num4 is the virtual register number of PubKSK. num5 is the virtual register number of PrvKSK_NTT. The CMux function is used in the Blind Rotate process executed in the Circuit Bootstrap instruction.

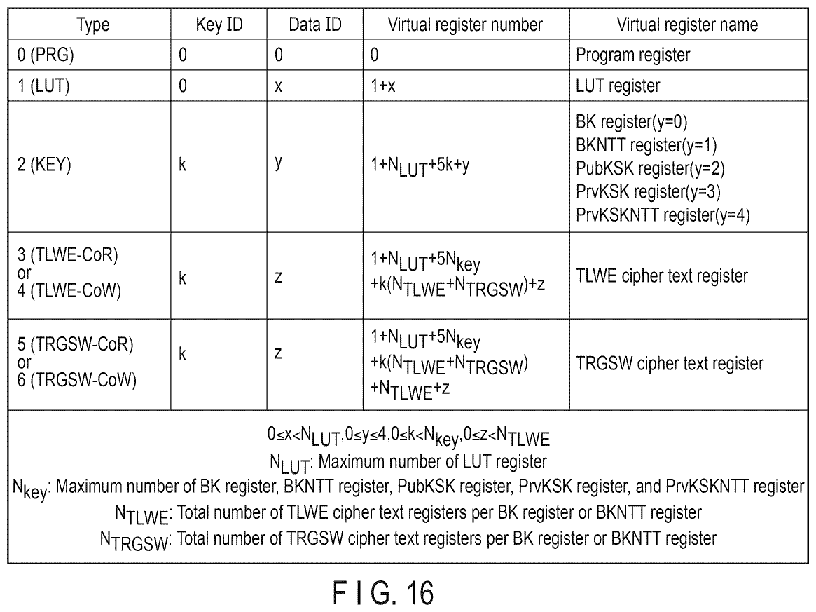

Next, an example of a method of computing the virtual register numbers will be described with reference to FIG. 16. The virtual registers in the present embodiment include the program register, LUT register, BK register, BKNTT register, PubKSK register, PrvKSK register, TLWE cipher text register, and TRGSW cipher text register. The entities of these registers exist in the main memory 113.

A program (sequence of computation instructions) is stored in the program register. A test vector of the TFHE is stored in the LUT register. The test vector (LUT) stored in the LUT register corresponds to, for example, a coefficient for a predetermined function (polynomial).

The bootstrapping key of the TFHE is stored in the BK register. The bootstrapping key stored in the BK register is used in the Gate Bootstrapping (GBS) of the TFHE and the like. Incidentally, the bootstrapping key may also be used in, for example, Programmable Bootstrapping (PBS). The PBS is a bootstrapping method of outputting the TLWE sample obtained by evaluating the input TLWE sample (cipher text) by homomorphic encryption using a predefined function after reducing its noise to a noise level of a new (fresh) sample.

The bootstrapping key of the TFHE, which is subjected to the number theoretic transform process, is stored in the BKNTT register.

The key switching key of the TFHE is stored in the PubKSK register and the PrvKSK register. More specifically, the key switching key used for the public functional key switching is stored in the PubKSK register. The key switching key used for the private functional key switching is stored in the PrvKSK register. The key switching keys stored in the PubKSK register and the PrvKSK register are generally used in the post-processing of the GBS or PBS (i.e., bootstrapping process).

The TLWE sample is stored in the TLWE cipher text register. There are two types of TLWE cipher text registers, i.e., TLWE-COR (COR register) and TLWE-CoW (CoW register).

The TRGSW sample is stored in the TRGSW cipher text register. There are two types of TRGSW cipher text registers, i.e., TRGSW-COR (COR register) and TRGSW-CoW (CoW register).

In FIG. 16, for example, when Type is 0, Key ID is 0, and Data ID is 0, the virtual register number “0” is computed from the Type, the Key ID, and the Data ID (i.e., content identifiers), indicating that the virtual register is the program register.

In addition, in FIG. 16, for example, when Type is 1, Key ID is 0, and Data ID is x, the virtual register number “1+x” is computed from the Type, the Key ID, and the Data ID (i.e., content identifiers), indicating that the virtual register is the LUT register.

Furthermore, in FIG. 16, for example, when Type is 2, Key ID is k, and Data ID is y, the virtual register number “1+N_{LUT}+5k+y” is computed from the Type, the Key ID, and the Data ID (i.e., content identifiers), indicating that the virtual register is the BK register, BKNTT register, PubKSK register, PrvKSK register, or PrvKSKNTT register. Incidentally, the virtual register at y=0 is the BK register, the virtual register at y=1 is the BKNTT register, the virtual register at y=2 is the PubKSK register, the virtual register at y=3 is the PrvKSK register, and the virtual register at y=4 is the PrvKSKNTT register.

Furthermore, in FIG. 16, for example, when Type is 3 or 4, Key ID is k, and Data ID is z, the virtual register number “1+N_{LUT}+5N_{key}+k(N_{TLWE}+N_{TRGSW})+z” is computed from the Type, Key ID and Data ID (i.e., content identifiers), indicating that the virtual register is the TLWE cipher text register. If Type is 3, it is indicated that this virtual register is the TLWE-COR (COR register). In addition, if the Type is 4, it is indicated that this virtual register is the TLWE-CoW (CoW register).

Furthermore, in FIG. 16, for example, when Type is 5 or 6, Key ID is k, and Data ID is z, the virtual register number “1+N_{LUT}+5N_{key}+k(N_{TLWE}+N_{TRGSW})+N_{TLWE}+z” is computed from the Type, the Key ID and the Data ID (i.e., content identifiers), indicating that the virtual register is the TRGSW cipher text register. If Type is 5, it is indicated that this virtual register is the TRGSW-COR (COR register). In addition, if Type is 6, it is indicated that this virtual register is the TRGSW-CoW (CoW register).

Incidentally, the x is assumed to be an integer greater than or equal to 0 and less than N_{LUT} (0≤x<N_{LUT}). y is assumed to be an integer greater than or equal to 0 and less than or equal to 4 (0≤y≤4). k is assumed to be an integer greater than or equal to 0 and less than N_{key} (0≤k<N_{key}). z is assumed to be an integer greater than or equal to 0 and less than N_{TLWE} (0≤z<N_{TLWE}).

N_{LUT} is the maximum number of LUT registers. N_{key} is the maximum number of BK registers, BKNTT registers, PubKSK registers, PrvKSK registers, and PrvKSKNTT registers. N_{TLWE} is the total number of TLWE cipher text registers per BK register or BKNTT register. N_{TRGSW} is the total number of TRGSW cipher text registers per BK register or BKNTT register.

Incidentally, it has been described that the accelerator 11 of the present embodiment operates in each of the CwR mode, CwW mode, CoR mode, and CoW mode. The operation mode of the accelerator 11 is specified in the computation options.

More specifically, when the read command is received from the host 20 and the Type of the computation option associated with the read data is TLWE-CoW, the operation mode of the accelerator 11 is the CwR mode.

In addition, when the write command is received from the host 20 and the Type of the computation option associated with the write data is TLWE-COR, the operation mode of the accelerator 11 is the CwW mode.

Furthermore, when the read command is received from the host 20 and the Type of the computation option associated with the read data is TLWE-COR, the operation mode of the accelerator 11 is the CoR mode.

Furthermore, when the write command is received from the host 20 and the Type of the computation option associated with the write data is TLWE-CoW, the operation mode of the accelerator 11 is the CoW mode.

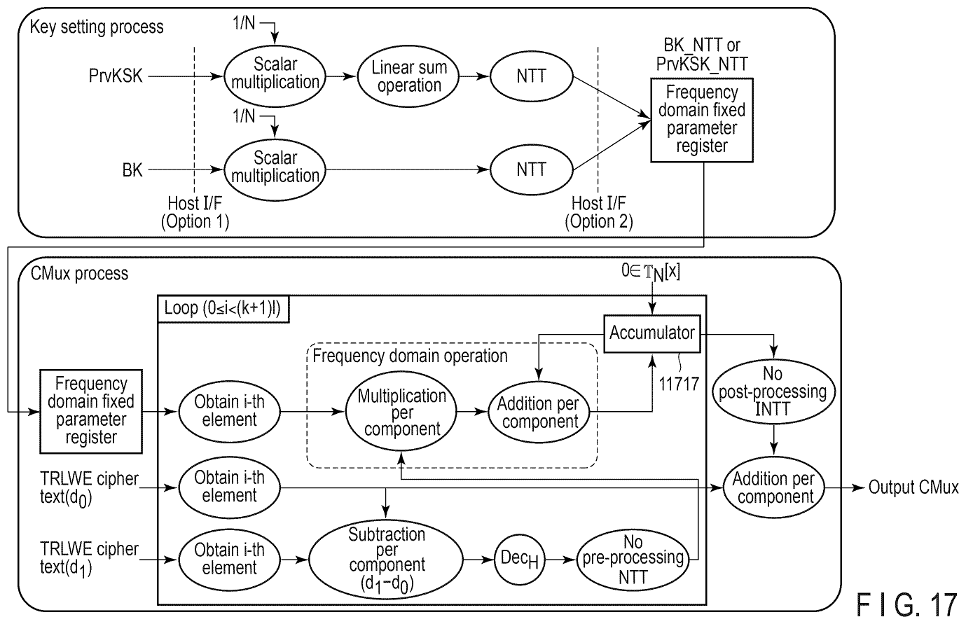

Next, the key setting process and the CMux function process will be described. FIG. 17 is a diagram illustrating an example of a procedure of a key setting process and CMux function process executed in the embodiment.

First, the key setting process using a private functional key switching key (PrvKSK) will be described.

The frequency domain key pre-computation circuit 1172 receives the private functional key switching key PrvKSK from the host 20 through the host interface 111.

The frequency domain key pre-computation circuit 1172 performs a scalar multiplication of multiplying the received private functional key switching key PrvKSK by 1/N.

The frequency domain key pre-computation circuit 1172 obtains a linear sum of the private functional key switching key PrvKSK/N subjected to the scalar multiplication (linear sum operation).

The frequency domain key pre-computation circuit 1172 performs the number theoretic transform (NTT) for the obtained linear sum.

The frequency domain key pre-computation circuit 1172 stores the frequency domain fixed parameter PrvKSK_NTT obtained by applying NTT in the frequency domain fixed parameter register. The frequency domain fixed parameter register is, for example, a part of the virtual register.

In addition, when the bootstrap key (BK) is used, the frequency domain key pre-computation circuit 1172 receives the bootstrap key BK from the host 20 through the host interface 111.

The frequency domain key pre-computation circuit 1172 performs a scalar multiplication of multiplying the received bootstrap key BK by 1/N.

The frequency domain key preliminary computation circuit 1172 performs the number theoretic transform (NTT) for the bootstrap key BK/N subjected to the scalar multiplication.

The frequency domain key pre-computation circuit 1172 stores the frequency domain fixed parameter BK_NTT obtained by applying the NTT, in the frequency domain fixed parameter register.

It has been described that the frequency domain key pre-computation circuit 1172 receives the key from the host 20 through the host interface 111 and performs the key setting process (option 1). However, the key setting process may be performed by the host 20 in advance and the frequency domain key pre-computation circuit 1172 may receive the frequency domain key subjected to the number theoretic transform from the host 20 through the host interface 111 (option 2).

The CMux operation circuit 1171 performs the processing of the CMux function, using the frequency domain fixed parameter generated by the key setting process. The CMux operation circuit 1171 uses the first TRLWE cipher text (d0), the second TRLWE cipher text (d1), and the frequency domain fixed parameter (BK_NTT or PrvKSK_NTT) as inputs, and outputs the third TRLWE cipher text as the output of the CMux function.

First, the CMux operation circuit 1171 obtains the i-th element of the first TRLWE cipher text (d0) and the i-th element of the second TRLWE cipher text (d1), and computes the fourth TRLWE cipher text (d1−d0) obtained by subtracting the i-th element of the first TRLWE cipher text (d0) from the obtained i-th element of the second TRLWE cipher text (d1). The CMux operation circuit 1171 computes the difference between components of the first TRLWE cipher text (d0) and components of the second TRLWE cipher text (d1) (i.e., 0≤i<(k+1)l).

Next, the CMux operation circuit 1171 computes the integer coefficient polynomial ring vector obtained by gadget-decomposing the computed fourth TRLWE cipher text (d1−d0). This computation is performed by, for example, the gadget decomposition computation circuit 11715.

The CMux operation circuit 1171 computes the frequency domain polynomial ring vector obtained by applying the NTT to each component of the integer coefficient polynomial ring vector obtained by the gadget decomposition.

Then, the CMux operation circuit 1171 computes the Hadamard product between the computed frequency domain polynomial ring vector and the frequency domain fixed parameter, based on the frequency domain fixed parameter stored in the frequency domain fixed parameter register. More specifically, the CMux operation circuit 1171 obtains the i-th element of the frequency domain fixed parameter, and computes the product between the i-th element of the obtained frequency domain fixed parameter and the i-th element of the frequency domain polynomial ring vector subjected to the NTT.

The CMux operation circuit 1171 computes the sum of the components of the computed Hadamard product. The computed sum is the inner product between the frequency domain fixed parameter and the frequency domain polynomial ring vector. More specifically, the inner product is computed by adding the product between the i-th elements of the two vectors to the value stored in the accumulator 11717. When i is 0, the initial value, i.e., 0 is stored in the accumulator 11717. When a loop of i from 0 to (k+1)l is repeated, the value stored in the accumulator 11717 is the sum of the components of the Hadamard product.

In addition, this inner product is also a frequency domain polynomial since each component of the frequency domain polynomial ring vector is a frequency domain polynomial.

Then, the CMux operation circuit 1171 computes the time-domain polynomial obtained by applying the INTT to the inner product stored in the accumulator 11717.

The CMux operation circuit 1171 obtains the third TRLWE cipher text by adding each component of the computed time-domain polynomial to each component of the first TRLWE cipher text (d0). The CMux operation circuit 1171 outputs the obtained third TRLWE cipher text as the output of the CMux function.

Incidentally, the host 20 of the present embodiment may be realized by a single information processing apparatus used by a plurality of users or realized by a plurality of information processing apparatuses connected to the CSD 10 through a network, and the like.

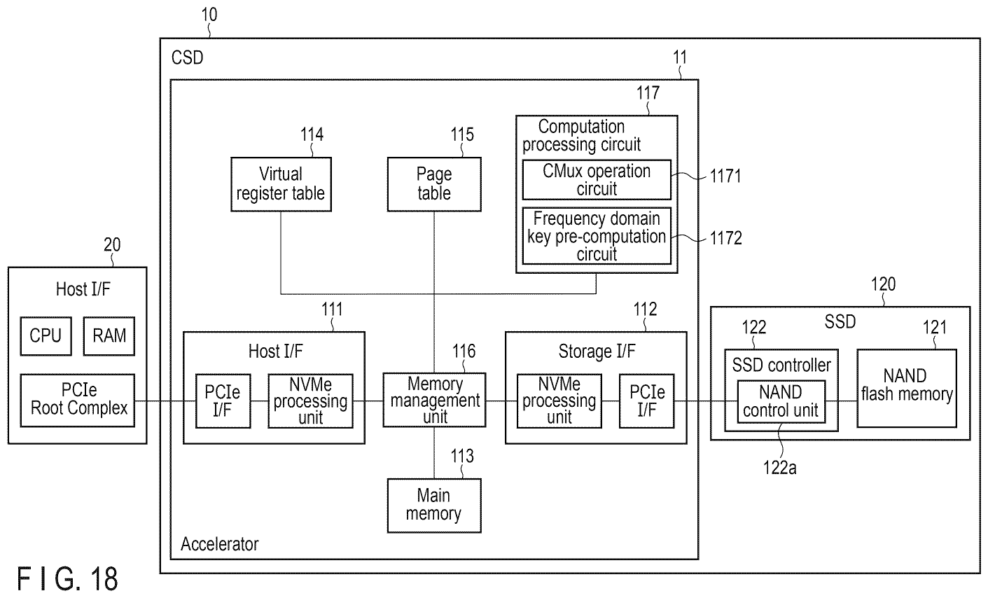

In addition, in the present embodiment, it is assumed that the storage 12 provided in the CSD 10 is, for example, a Solid State Drive (SSD) 120 including a NAND flash memory 121 as a nonvolatile memory, as shown in FIG. 18. In this case, the CSD 10 is configured to be connectible to, for example, the host 20 through a system bus such as a Peripheral Component Interconnect Express™ (PCIe™) bus. In addition, for example, Non-Volatile MEMORY Express™ (NVMe™) is employed as the communication protocol between the CSD 10 and the host 20. In other words, the CSD 10 (host interface 111) is configured to be connectible to the host 20 (i.e., to execute communication with the host 20), based on the NVMe standard. In this case, the host 20 includes a device referred to as Root Complex with a PCIe port in addition to the CPU, RAM, and the like. In addition, each of the host interface 111 and the storage interface 112 provided in the accelerator 11 includes a PCIe interface (I/F) that executes processing according to the PCIe standard and an NVMe processing unit that performs processing according to the NVMe standard. In this case, the I/O commands (read and write commands) described in the present embodiment correspond to the commands (NVMeRead commands and NVMeWrite commands) that comply with the NVMe standard. In addition, the host data and metadata attached to the host data described in the present embodiment correspond to NVMe data and NVMe metadata.

In addition to the NAND flash memory 121, the SSD 120 comprises an SSD controller 122 that controls the NAND flash memory 121. The SSD controller 122 comprises a NAND control unit 122a that instructs read and write operations to the NAND flash memory 121 through the NAND interface, based on requests received from the storage interface 112. In addition, the NAND control unit 122a also instructs read operations, write operations, erase operations, and the like to the NAND flash memory 121 through the NAND interface in background processing, regardless of the requests received through the storage interface 112.

Furthermore, the NAND control unit 122a manages the data storage area in the NAND flash memory 121 as a physical address, and maps logical addresses to physical addresses by using an address translation table.

Thus, in FIG. 18, the computation processing circuit 117, including the CMux operation circuit 1171 and the frequency domain key pre-computation circuit 1172, is included in the accelerator 11 included in the CSD 10, which is configured to execute communication with the host 20 based on the NVMe standard. Therefore, the accelerator 11 can preliminarily compute the first frequency domain polynomial ring vector (frequency domain fixed parameter) by executing the process of multiplying each of one or more constant polynomials, which is a component of the bootstrapping key (or private functional key switching key), i.e., the polynomial ring vector over the integer coefficient polynomial ring using polynomial x^{N}+1 as the ideal, by 1/N, and the process of applying the number theoretic transform. Then, the accelerator 11 can execute the operation between the polynomials such as the CMux function operation, by using the frequency domain fixed parameter computed in advance, instead of the bootstrapping key or the private functional key switching key received from the host 20, which is not computed in advance.

Incidentally, the accelerator 11 may execute the process of receiving the frequency domain fixed parameter computed in advance in the host 20 from the host 20 and the process of storing the received frequency domain fixed parameter in the main memory 113. When executing the operation of polynomials such as the CMux function operation, the accelerator 11 (CMux operation circuit 1171) can execute the operation between the polynomials such as the CMux function operation at a high speed by reading the corresponding frequency domain fixed parameter from the main memory 113 and using the read frequency domain fixed parameter instead of the bootstrapping key or private functional key switching key received from the host 20.

In FIG. 18, it is assumed that the SSD controller 122 is arranged inside the SSD 120 (i.e., the accelerator 11 is provided outside the SSD controller 122), but the accelerator 11 of the present embodiment may also be arranged inside the SSD controller 122.

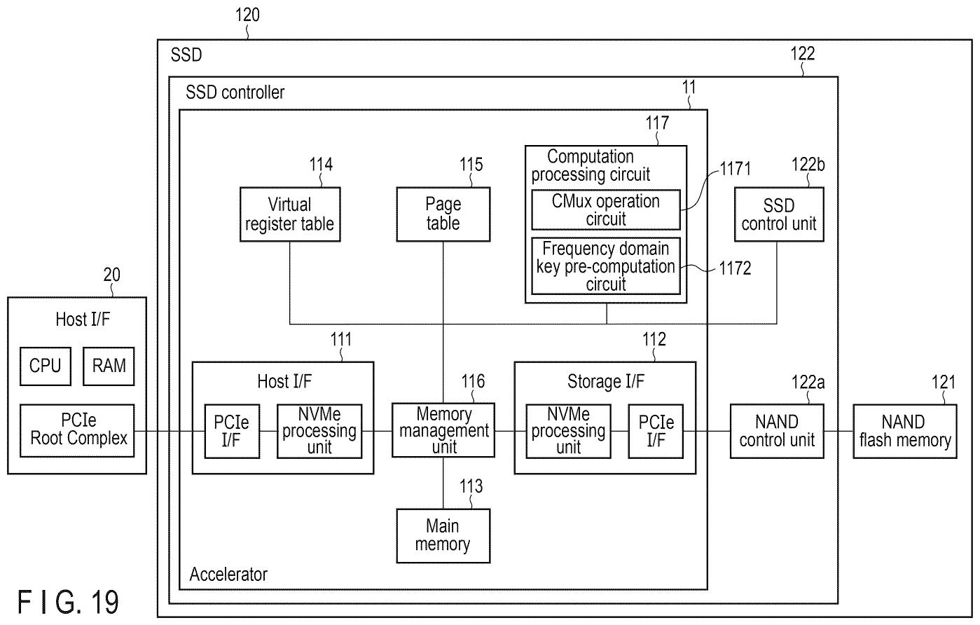

FIG. 19 shows an example of a configuration in which the accelerator 11 is arranged inside the SSD controller 122. According to the example shown in FIG. 19, the SSD 120 comprises the NAND flash memory 121 and the SSD controller 122. The SSD controller 122 comprises the accelerator 11 and the SSD control unit 122b in addition to the NAND control unit 122a. In FIG. 19, it is shown that the NAND control unit 122a and the SSD control unit 122b are realized by, for example, hardware, but at least several parts of the entire NAND control unit 122a and SSD control unit 122b may be realized by a processor provided in the SSD controller 122 to execute predetermined programs (i.e., software). The SSD control unit 122b comprises a function of controlling the operation of the SSD 120. The SSD 120 in the example shown in FIG. 19 may correspond to the CSD 10 described in the present embodiment. In addition, in the configuration shown in FIG. 19, the SSD 120 may be referred to as a memory system, and the SSD controller 122 may be referred to as a memory controller.

Thus, in FIG. 19, the computation processing circuit 117 including the CMux operation circuit 1171 and the frequency domain key pre-computation circuit 1172 is included in the accelerator 11 included in the CSD 10, which is configured to execute communication with the host 20 based on the NVMe standard. The CSD 10 includes the NAND flash memory 121 and the SSD controller 122 configured to control the NAND flash memory 121. The accelerator 11 is included in the SSD controller 122. In this configuration as well, the accelerator 11 can execute the same process as that described in FIG. 18.

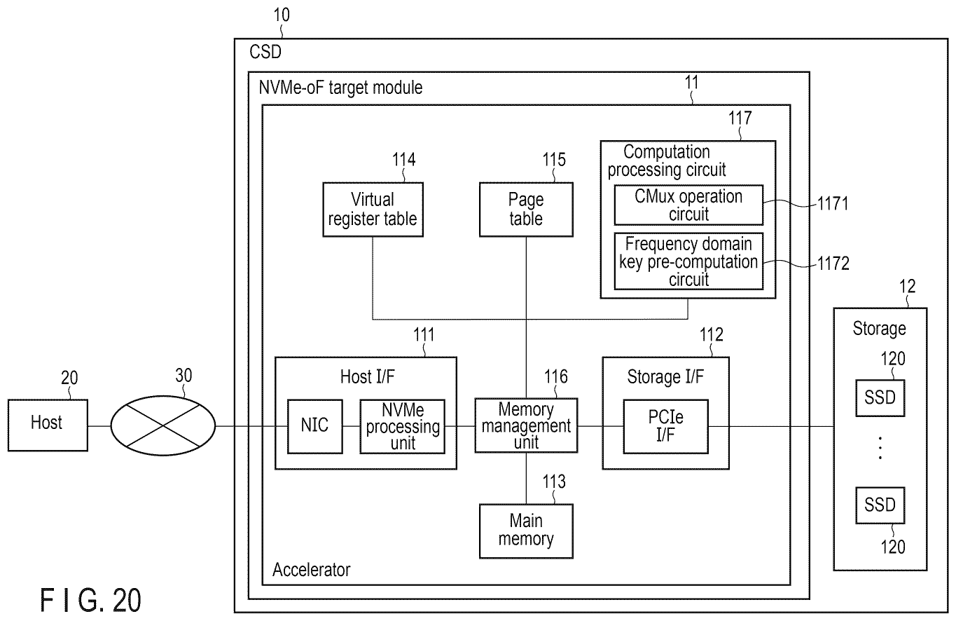

Furthermore, as shown in FIG. 20, the CSD 10 may be configured to be connectible to the host 20 through the network 30. In this case, for example, NVMe over Fabric (NVMe-oF) is used as the communication protocol between the CSD 10 and the host 20, and the accelerator 11 is arranged inside an NVMe-oF target module of the CSD 10. In other words, the accelerator 11 is configured to be connectible to the host 20 through the network 30 in compliance with the NVMe-oF standard. Incidentally, in the example shown in FIG. 20, the host interface 111 provided in the host interface 11 includes an NVMe-oF processing unit that executes processes compliant with Network Interface Card (NIC) and the NVMe-oF standard. In addition, in the example shown in FIG. 20, the storage 12 comprises a plurality of SSD 120, and the storage interface 112 includes a PCIe switch that executes switching of the plurality of SSD 120.

Thus, in FIG. 20, the computation processing circuit 117 including the CMux operation circuit 1171 and the frequency domain key pre-computation circuit 1172 is included in the accelerator 11 included in the CSD 10, which is configured to execute communication with the host 20 based on the NVM Express over Fabrics protocol. In this configuration as well, the accelerator 11 can execute the same process as that described in FIG. 18.

Incidentally, FIG. 18 to FIG. 20 are prepared to illustrate the example of application of the accelerator 11 of the present embodiment, and the configuration shown in FIG. 18 to FIG. 20 may be modified as necessary.

In addition, in the present embodiment, it has been described that the accelerator 11 (controller) and the storage 12 configure one device (computing storage device), but the controller and the storage may be arranged as separate devices.

As described above, according to the embodiment, when computing the inner product between two polynomial ring vectors, the polynomial ring vector inner product operation circuit 11714 computes an Hadamard product between a first frequency domain polynomial ring vector and a second frequency domain polynomial ring vector which is obtained by applying the NTT to each component of the polynomial ring vector, based on the first frequency domain polynomial ring vector computed in advance, computes an inner product by computing a sum of the components of the computed Hadamard product, and outputs the time-domain polynomial obtained by applying the INTT to the inner product.

As a result, when computing the inner product between two polynomial ring vectors, the polynomial ring vector inner product operation circuit 11714 can skip the computation of multiplying by 1/N and the process of applying the NTT, which are required for computing the first polynomial ring vector. Therefore, the time required for the process of multiplying by 1/N can be eliminated, and the number of times of executing the NTT process can be halved. The NTT process to compute the second frequency domain polynomial ring vector is needed.

Thus, the amount of computation required for computing the inner product between the polynomial ring vectors can be reduced, and the polynomial ring vector inner product computation circuit 11714 can efficiently execute the computation of encrypted data in which polynomial ring vectors are used.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A polynomial ring vector inner product computation circuit being configured to compute an inner product between a first polynomial ring vector and a second polynomial ring vector, where each component of at least the first polynomial ring vector, of the first polynomial ring vector and the second polynomial ring vector over an integer coefficient polynomial ring using polynomial x^{N}+1 as an ideal, is a linear sum of one or more constant polynomials, the N being a power of 2,
the polynomial ring vector inner product computation circuit comprising:
a number theoretic transform processing circuit configured to compute a frequency domain polynomial ring vector obtained by applying number theoretic transform to each component of a polynomial ring vector;
an Hadamard inner product computation circuit configured to compute an Hadamard product between a first frequency domain polynomial ring vector and a second frequency domain polynomial ring vector that is obtained by applying number theoretic transform to each component of the second polynomial ring vector by the number theoretic transform processing circuit, based on the first frequency domain polynomial ring vector having as each component a linear sum of a frequency domain constant polynomial that is obtained by preliminarily executing a process of multiplying each of the one or more constant polynomials by 1/N and a process of applying number theoretic transform to each of the one or more constant polynomials, and computing a first inner product, which is a frequency domain polynomial, by computing a sum of components of the computed Hadamard product;
an inverse number theoretic transform processing circuit configured to compute a time domain polynomial obtained by applying inverse number theoretic transform to the first inner product; and
an inner product output circuit configured to output the computed time domain polynomial.

2. The polynomial ring vector inner product computation circuit of claim 1, further comprising:
a preliminary computation circuit configured to compute the first frequency domain polynomial ring vector by executing in advance the process of multiplying each of the one or more constant polynomials by 1/N and the process of applying the number theoretic transform to each of the one or more constant polynomials, wherein
the Hadamard inner product computation circuit computes the Hadamard inner product between the first frequency domain polynomial ring vector and the second frequency domain polynomial ring vector, based on the first frequency domain polynomial ring vector preliminarily computed by the preliminary computation circuit.

3. The polynomial ring vector inner product computation circuit of claim 1, wherein
the polynomial ring vector inner product computation circuit is included in an accelerator that is included in a computing storage device that is configured to execute communication with a host based on NVM Express standard, and
the Hadamard inner product computation circuit computes the Hadamard inner product between the first frequency domain polynomial ring vector and the second frequency domain polynomial ring vector, based on the first frequency domain polynomial ring vector preliminarily computed in the host and received from the host.

4. The polynomial ring vector inner product computation circuit of claim 1, wherein
the polynomial ring vector inner product computation circuit is included in an accelerator that is included in a computing storage device being configured to execute communication with a host based on NVM Express standard, and
the computing storage device includes a nonvolatile memory and a controller being configured to control the nonvolatile memory, and
the accelerator is included in the controller.

5. The polynomial ring vector inner product computation circuit of claim 1, wherein
the polynomial ring vector inner product computation circuit is included in an accelerator that is included in a computing storage device being configured to execute communication with a host based on NVM Express over Fabrics protocol.

6. A computation processing circuit being configured to compute CMux function, the CMux function including: an operation to input a first TRLWE sample, which is a cipher text of Torus Fully Homomorphic Encryption (THE) that is obtained by encrypting a first plain text, a second TRLWE sample, which is a cipher text of the TFHE obtained by encrypting a second plain text, and a frequency domain TRGSW sample, which is a cipher text of the TFHE obtained by encrypting 0 or 1; an operation to output a third TRLWE sample, which is a cipher text of the TFHE obtained by encrypting the first plain text when the frequency domain TRGSW sample is the cipher text obtained by encrypting 0; and an operation to output the third TRLWE sample, which is a cipher text of the TFHE obtained by encrypting the second plain text when the frequency domain TRGSW sample is the cipher text obtained by encrypting 1,
the computation processing circuit comprising:
a subtraction-per-component circuit configured to compute a fourth TRLWE sample that is obtained by subtracting each component of the first TRLWE sample from each component of the second TRLWE sample;
a gadget decomposition computation circuit configured to compute an integer coefficient polynomial ring vector that is obtained by gadget decomposing the fourth TRLWE sample;
a polynomial ring vector inner product computation circuit; and
an addition-per-component circuit, wherein
the frequency domain TRGSW sample is a first frequency domain polynomial ring vector that has as each component a linear sum of the frequency domain constant polynomials obtained by preliminarily executing a process of multiplying each of one or more constant polynomials, which is a component of a bootstrapping key or a private functional key switching key, which is a polynomial ring vector over an integer coefficient polynomial ring using polynomial x^{N}+1 as the ideal, by 1/N and a process of applying the number theoretic transform to each of one or more constant polynomials,
the N is a power of 2,
the polynomial ring vector inner product computation circuit is configured to:
compute a second frequency domain polynomial ring vector obtained by applying number theoretic transform to each component of the integer coefficient polynomial ring vector;
compute an Hadamard product between the first frequency domain polynomial ring vector and the second frequency domain polynomial ring vector, based on the first frequency domain polynomial ring vector;
compute a first inner product, which is a frequency domain polynomial, by computing a sum of components of the computed Hadamard product; and
compute a time domain polynomial obtained by applying inverse number theoretic transform to the first inner product, and
the addition-per-component circuit is configured to output the third TRLWE sample obtained by adding each component of the first TRLWE sample to each component of the computed time domain polynomial.

7. The computation processing circuit of claim 6, further comprising:
a preliminary computation circuit preliminarily computing the first frequency domain polynomial ring vector by preliminarily executing the process of multiplying each of the one or more constant polynomials by 1/N and the process of applying the number theoretic transform to each of the one or more constant polynomials, wherein
the polynomial ring vector inner product computation circuit computes the Hadamard inner product between the first frequency domain polynomial ring vector and the second frequency domain polynomial ring vector, based on the first frequency domain polynomial ring vector preliminarily computed by the preliminary computation circuit.

8. The computation processing circuit of claim 6,
wherein the computation processing circuit is included in an accelerator included in a computing storage device being configured to execute communication with a host based on NVM Express standard, and
the polynomial ring vector inner product computation circuit computes the Hadamard inner product between the first frequency domain polynomial ring vector and the second frequency domain polynomial ring vector, based on the first frequency domain polynomial ring vector preliminarily computed in the host and received from the host.

9. The computation processing circuit of claim 6, wherein
the computation processing circuit is included in an accelerator that is included in a computing storage device being configured to execute communication with a host based on NVM Express standard,
the computing storage device includes a nonvolatile memory and a controller being configured to control the nonvolatile memory, and
the accelerator is included in the controller.

10. The computation processing circuit of claim 6, wherein
the computation processing circuit is included in an accelerator included in a computing storage device being configured to execute communication with a host based on NVM over Fabrics protocol.

11. A control method of executing by a polynomial ring vector inner product computation circuit a process of computing an inner product between a first polynomial ring vector and a second polynomial ring vector, where each component of at least the first polynomial ring vector, of the first polynomial ring vector and the second polynomial ring vector over an integer coefficient polynomial ring using polynomial x^{N}+1 as an ideal, is a linear sum of one or more constant polynomials, the N being a power of 2,
the control method comprising:
reading, from a memory, a first frequency domain polynomial ring vector that has as each component a linear sum of a frequency domain constant polynomial that is obtained by preliminarily executing a process of multiplying each of the one or more constant polynomials by 1/N and a process of applying number theoretic transform to each of the one or more constant polynomials;
computing an Hadamard product between the first frequency domain polynomial ring vector and a second frequency domain polynomial ring vector that is obtained by applying number theoretic transform to each component of the second polynomial ring vector, based on the first frequency domain polynomial ring vector, and computing a sum of components of the computed Hadamard product, and thereby computing a first inner product, which is a frequency domain polynomial;
computing a time domain polynomial that is obtained by applying inverse number theoretic transform to the first inner product; and
outputting the computed time domain polynomial.

12. The control method of claim 11, further comprising:
executing a process of preliminarily computing the first frequency domain polynomial ring vector by executing in advance the process of multiplying each of the one or more constant polynomials by 1/N and the process of applying the number theoretic transform to each of the one or more constant polynomials; and
storing the preliminarily computed first frequency domain polynomial ring vector in the memory.

13. The control method of claim 11, wherein
the polynomial ring vector inner product computation circuit and the memory are included in an accelerator that is included in a computing storage device being configured to execute communication with a host based on NVM Express standard,
the control method further comprising:
receiving, from the host by the accelerator, the first frequency domain polynomial ring vector preliminarily computed by the host; and
storing the received first frequency domain polynomial ring vector into the memory by the accelerator.

14. A control method of computing a CMux function by a computation processing circuit, the CMux function including an operation to input a first TRLWE sample, which is a cipher text of Torus Fully Homomorphic Encryption (TFHE) that is obtained by encrypting a first plain text, a second TRLWE sample, which is a cipher text of the TFHE obtained by encrypting a second plain text, and a frequency domain TRGSW sample, which is a cipher text of the TFHE obtained by encrypting 0 or 1; an operation to output a third TRLWE sample, which is a cipher text of the TFHE obtained by encrypting the first plain text when the frequency domain TRGSW sample is the cipher text obtained by encrypting 0; and an operation to output the third TRLWE sample, which is a cipher text of the TFHE obtained by encrypting the second plain text when the frequency domain TRGSW sample is the cipher text obtained by encrypting 1,
the frequency domain TRGSW sample being a first frequency domain polynomial ring vector that has as each component a linear sum of the frequency domain constant polynomials obtained by preliminarily executing a process of multiplying each of one or more constant polynomials, which is a component of a bootstrapping key or a private functional key switching key, which is a polynomial ring vector over an integer coefficient polynomial ring using polynomial x^{N}+1 as the ideal, by 1/N and a process of applying the number theoretic transform to each of one or more constant polynomials,
the N being a power of 2,
the control method comprising:
computing a fourth TRLWE sample that is obtained by subtracting each component of the first TRLWE sample from each component of the second TRLWE sample;
computing an integer coefficient polynomial ring vector that is obtained by gadget decomposing the fourth TRLWE sample;
computing a second frequency domain polynomial ring vector that is obtained by applying number theoretic transform to each component of the integer coefficient polynomial ring vector;
reading the first frequency domain polynomial ring vector from a memory;
computing an Hadamard product between the first frequency domain polynomial ring vector and the second frequency domain polynomial ring vector, based on the first frequency domain polynomial ring vector, computing a sum of components of the computed Hadamard product, and thereby computing a first inner product, which is a frequency domain polynomial;
computing a time domain polynomial that is obtained by applying inverse number theoretic transform to the first inner product; and
outputting the third TRLWE sample obtained by adding each component of the first TRLWE sample to each component of the computed time domain polynomial.

15. The control method of claim 14, further comprising:
executing by a preliminary computation circuit a process of preliminarily computing the first frequency domain polynomial ring vector by executing in advance the process of multiplying each of the one or more constant polynomials by 1/N and the process of applying the number theoretic transform to each of the one or more constant polynomials; and
storing the preliminarily computed first frequency domain polynomial ring vector in the memory.

16. The control method of claim 14, wherein
the computation processing circuit and the memory are included in an accelerator included in a computing storage device being configured to execute communication with a host based on NVM Express standard,
the control method further comprising:
receiving the first frequency domain polynomial ring vector preliminarily computed by the host from the host by the accelerator; and
storing the received first frequency domain polynomial ring vector in the memory by the accelerator.
